(19) United States
(12) Patent Application Publication
(10) Pub. No.: US 2008/0224964 A1
(43) Pub. Date: Sep. 18, 2008

(54) Display apparatus, display-apparatus driving method and electronic equipment

(75) Inventors: Takao Tanikame, Kanagawa (JP); Yukihito Iida, Kanagawa (JP); Tetsuo Minami, Tokyo (JP); Katsuhide Uchino, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/071,853

(22) Filed: Feb. 27, 2008

(30) Foreign Application Priority Data
Mar. 16, 2007 (JP) 2007-068003

(51) Int. Cl. G09G 3/30; G09G 3/20

(52) U.S. Cl. 345/76; 345/55

(57) ABSTRACT

In the present invention, there is provided a display apparatus including: a pixel array section including pixel circuits each having an electro-optical device, a write transistor configured to carry out a voltage storing process, a holding capacitor configured to hold the sampled video signal, and a driving transistor configured to drive the electro-optical device; first scan means for carrying out a selective scan operation in row units and driving each of the write transistors; second scan means for selectively supplying either a first or second electric potential synchronously with the selective scan operation for feeding a current to each of the driving transistors; and control means for sustaining a power-supply feed line in a floating state during a period ending at a time not earlier than the start of the voltage storing process after a voltage corresponding to the threshold voltage of the driving transistor has been held in the holding capacitor.

### CROSS REFERENCES TO RELATED APPLICATIONS

The present invention contains subject matter related to Japanese Patent Application JP 2007-068003 filed in the Japan Patent Office on Mar. 16, 2007, the entire contents of which being incorporated herein by reference.

### BACKGROUND OF THE INVENTION

1. Field of the Invention

The present invention relates to a display apparatus, a method for driving the display apparatus and electronic equipment. More particularly, the present invention relates to a display apparatus of a flat-panel type, in which pixel circuits each including an electro-optical device are laid out to form a matrix, a method for driving the display apparatus and electronic equipment employing the display apparatus.

2. Description of the Related Art

In recent years, in the field of a display apparatus for displaying an image, a display apparatus of a flat-panel type, in which pixels (or pixel circuits) each including a light emitting device are laid out to form a matrix, has been becoming popular very fast. A light emitting device included in each pixel circuit in the display apparatus of a flat-panel type is an electro-optical device of the so-called current-driven type in which the luminance of a light beam emitted by the device changes in accordance with the magnitude of a current flowing through the device. The development of an organic EL (Electro Luminescence) display apparatus employing such electro-optical devices into a commercial product has been making progress. An example of the electro-optical device of the so-called current-driven type is an organic EL device operating on the basis of a phenomenon in which a light beam is generated by the device when an electric field is applied to an organic film.

The organic EL display apparatus has the following characteristics. The organic EL device employed in the EL display apparatus can be driven by an applied voltage not exceeding 10V so that the power consumption of the device is low. In addition, since the organic EL device is a light emitting device, the organic EL display apparatus is capable of displaying an image which is visible in comparison with a liquid crystal display apparatus for displaying an image by controlling the intensity of a light beam generated by a light source known as a backlight in a liquid crystal cell included in every pixel circuit of the liquid crystal display apparatus. On top of that, the organic EL display apparatus can be made light and thin with ease because the organic EL display apparatus does not need illumination members such as the backlight which is necessary for the liquid crystal display apparatus. Furthermore, the organic EL device has an extremely high speed providing a short response time of the order of several microseconds. Thus, a residual image is not generated in an operation to display a moving image.

Much like the liquid crystal display apparatus, a passive matrix method or an active matrix method can be adopted as a method for driving the organic EL display apparatus. However, even though an organic EL display apparatus adopting the passive matrix method has a simple structure, the apparatus raises problems such as difficulties to implement a large display screen having a high resolution.

For the reasons described above, an organic EL display apparatus adopting an active matrix method is developed aggressively. In accordance with this active matrix method, an active device is provided in the same pixel circuit as an electro-optical device. The active device is used for controlling a current flowing through the electro-optical device. An example of the active device is an insulated-gate type field effect transistor which is generally a TFT (thin film transistor). Since every electro-optical device in the organic EL display apparatus adopting the active matrix method sustains a generated light beam throughout the period of 1 frame, the apparatus can be used for implementing a large display screen having a high resolution.

Incidentally, the I-V characteristic (that is, the current-voltage characteristic) of an organic EL device is known to deteriorate with the lapse of time in the so-called aging process. In a pixel circuit employing an N-channel TFT for controlling a current flowing through the organic EL device, the organic EL device is connected to the source of the transistor which is referred to hereafter as a driving transistor. Thus, when the I-V characteristic of the organic EL device deteriorates, a voltage Vgs appearing between the gate and source of the driving transistor changes. As a result, the intensity of a light beam generated by the organic EL device also changes as well.

To put it more concretely, an electric potential appearing at the source of the driving transistor is determined by the operating points of the driving transistor and the organic EL device. When the I-V characteristic of the organic EL device deteriorates, the operating points of the driving transistor and the organic EL device change. Thus, the electric potential appearing at the source of the driving transistor also changes even if a voltage applied to the gate of the transistor after the operating points of the driving transistor and the organic EL device change is sustained at the same level as that before the operating points of the driving transistor and the organic EL device change. Accordingly, the voltage Vgs appearing between the gate and source of the driving transistor also changes as well, causing a current flowing through the transistor and a current flowing through the organic EL device to vary. As a result, since the current flowing through the organic EL device varies, the intensity of a light beam generated by the organic EL device also changes as well.

In addition, in the case of a pixel circuit employing a poly-silicon TFT, not only does the I-V characteristic of the organic EL device deteriorate with the lapse of time, but the threshold voltage Vth of the driving transistor and the mobility μ of a semiconductor film composing the channel of the transistor also change with the lapse of time. In the following description, the mobility μ of a semiconductor film composing the channel of a driving transistor is referred to as the mobility μ of the driving transistor. Furthermore, the threshold voltage Vth and mobility μ of the driving transistor each vary from pixel to pixel due to variations in fabrication process. That is to say, the characteristic of the driving transistor varies from pixel to pixel.

If the threshold voltage Vth and mobility μ of the driving transistor each vary from pixel to pixel, the current flowing through the transistor also varies from pixel to pixel. Thus, the luminance of a light beam generated by the organic EL device also varies from pixel to pixel even for the same voltage applied to the gate of each driving transistor. As a result, the screen loses uniformity.

In order to prevent the luminance of a light beam generated by the organic EL device from varying from pixel to pixel even for the same voltage applied to the gate of each driving transistor and, hence, from being affected by deteriorations of the I-V characteristic of the organic EL device and/or changes of the threshold voltage Vth and mobility μ of the driving transistor even if the I-V characteristic deteriorates with the lapse of time and/or the threshold voltage Vth and the mobility μ change with the lapse of time, it is necessary to provide every pixel circuit with a compensation function and a variety of correction functions as is described in documents such as patent reference 1 which is Japanese Patent Laid-open No. 2006-133542. The compensation function is a function to compensate for characteristic variations of the organic EL device. The correction functions include a threshold-voltage correction function and a mobility correction function. The threshold-voltage correction function is a function to make corrections for threshold voltage (Vth) variations of the driving transistor. On the other hand, the mobility correction function is a function to make corrections for mobility (μ) variations of the driving transistor.

### SUMMARY OF THE INVENTION

In accordance with the technology disclosed in patent reference 1, in order to prevent the luminance of a light beam generated by the organic EL device from varying from pixel to pixel even for the same voltage applied to the gate of each driving transistor and, hence, from being affected by deteriorations of the I-V characteristic of the organic EL device and/or changes of the threshold voltage Vth and mobility μ of the driving transistor even if the I-V characteristic deteriorates with the lapse of time and/or the threshold voltage Vth and the mobility μ change with the lapse of time, every pixel circuit is provided with a compensation function to compensate for characteristic variations of the organic EL device, the threshold-voltage correction function to make corrections for threshold voltage (Vth) variations of the driving transistor and the mobility correction function to make corrections for mobility (μ) variations of the driving transistor. By providing every pixel circuit with such functions, however, the number of components composing the pixel circuit increases, making it difficult to miniaturize the pixel circuit and, hence, difficult to increase the resolution of the display apparatus.

In order to reduce the number of components composing the pixel circuit and wires included in the circuit, for example, it is conceivable to adopt a technique of providing a configuration which allows a power-supply electric potential supplied to the driving transistor employed in the pixel circuit to be changed from one to another. The capability of changing the power-supply electric potential supplied to the driving transistor employed in the pixel circuit from one to another is equivalent to a function provided to the driving transistor as a function for controlling the light emitting period/the no-light emitting period of the organic EL device. It is thus possible to eliminate a transistor for controlling the light emitting period/the no-light emitting period of the organic EL device.

By adopting the method described above, the number of components composing the pixel circuit can be minimized. To put it concretely, it is possible to configure the pixel circuit to include a write transistor, a holding capacitor and a driving transistor. The write transistor is a transistor for sampling the voltage of a video signal and holding the sampled voltage in the pixel circuit. The voltage holding capacitor is a capacitor for keeping the sampled signal voltage held in the pixel circuit by the write transistor. The driving transistor is a transistor for driving the organic EL device on the basis of the signal voltage held by the voltage holding capacitor.

In the configuration described above, the driving transistor also functions as a transistor for controlling the light emitting period/the no-light emitting period of the organic EL device. Thus, the number of components composing the pixel circuit can be reduced. In this configuration, the power-supply electric potential supplied to the driving transistor employed in the pixel circuit can be changed from a high level to a low level and vice versa. However, if the power-supply electric potential supplied to the driving transistor employed in the pixel circuit is sustained at the high level as it is after a voltage corresponding to the threshold voltage Vth of the driving transistor has been held for threshold-voltage correction in the voltage holding capacitor connected between the gate and source of the driving transistor, a leak current flows to the driving transistor so that the desired threshold-voltage correction may not be carried out as will be described later in detail.

In order to solve the problems described above, inventors of the present invention have innovated a display apparatus capable of carrying out a desired threshold-voltage correction process with a high degree of reliability in a configuration in which: a driving transistor also functions as a transistor for controlling the light emitting period/the no-light emitting period of an electro-optical device; and a power-supply electric potential supplied to the driving transistor is changed from a high level to a low level and vice versa in order to control the light emitting period/the no-light emitting period of the electro-optical device. In addition, the inventors have also innovated a method for driving the display apparatus and electronic equipment employing the display apparatus.

In accordance with the present invention for solving the problems described above, there is provided a display apparatus including a pixel array section including pixel circuits laid out to form a matrix as pixel circuits each having an electro-optical device, a write transistor configured to carry out a voltage storing process to sample a video signal and store the sampled video signal into the pixel circuit, a holding capacitor configured to hold the sampled video signal stored in the pixel circuit by the write transistor, and a driving transistor configured to drive the electro-optical device on the basis of the video signal held by the holding capacitor. The display apparatus further includes first scan means connected to rows of the pixel circuits in the pixel array section for carrying out a selective scan operation on the pixel circuits in the pixel array section in row units and driving each of the write transistors to carry out the voltage storing process; second scan means connected to the rows of the pixel circuits in the pixel array section for selectively supplying either a first electric potential or a second electric potential lower than the first electric potential synchronously with the selective scan operation carried out by the first scan means to power-supply feed lines for feeding a current to each of the driving transistors; and control means for sustaining the power-supply feed line in a floating state during a period ending at a time not earlier than the start of the voltage storing process carried out by the write transistor to store the video signal in the holding capacitor after a voltage corresponding to the threshold voltage of the driving transistor has been held in the holding capacitor prior to the voltage storing process.

In the display apparatus having a configuration explained above and the electronic equipment employing the display apparatus, after a voltage corresponding to the threshold voltage of the driving transistor has been held in the voltage holding capacitor prior to the voltage storing process carried out by the write transistor to store a video signal in the voltage holding capacitor, the power-supply feed line is sustained in a floating state during a period ending at a time not earlier than the start of the voltage storing process. Thus, a leak current does not flow to the driving transistor. If a leak current does not flow to the driving transistor, an electric potential appearing at the source of the driving transistor does not change. Therefore, a voltage appearing between the gate and source of the driving transistor is sustained at a voltage held in the voltage holding capacitor as the voltage corresponding to the threshold voltage of the driving transistor. As a result, in a subsequent voltage storing process to store a next video signal in the voltage holding capacitor, a desired threshold-voltage correction can be carried out with a high degree of reliability.

In accordance with the present invention, a leak current is prevented from flowing to the driving transistor. Thus, in a voltage storing process to store a video signal in the voltage holding capacitor, a desired threshold-voltage correction can be carried out with a high degree of reliability. Therefore, it is possible to flow a constant current to the electro-optical device as a current not affected by threshold-voltage variations among driving transistors and/or driving-transistor threshold-voltage changes with the lapse of time. As a result, a displayed image having a high quality can be obtained.

### BRIEF DESCRIPTION OF THE DRAWINGS

FIG. 1 is a system configuration diagram roughly showing the configuration of an organic EL display apparatus according to an embodiment of the present invention;

FIG. 2 is a circuit diagram showing a typical concrete configuration of a pixel (or a pixel circuit) employed in the organic EL display apparatus;

FIG. 3 is a diagram showing a typical cross-sectional structure of the pixel circuit;

FIG. 4 is an explanatory diagram showing timing charts to be referred to in description of operations carried out by the circuit of the organic EL display apparatus according to the embodiment of the present invention;

FIGS. 5A to 6E are explanatory diagrams in description of operations carried out by the circuit of the organic EL display apparatus according to the embodiment of the present invention;

FIG. 7 is an explanatory characteristic diagram to be referred to in description of a problem caused by variations of the threshold voltage Vth of a driving transistor from pixel to pixel;

FIG. 8 is an explanatory characteristic diagram to be referred to in description of a problem caused by variations of the mobility μ of a driving transistor from pixel to pixel;

FIGS. 9A to 9C are diagrams showing curves each representing a relation between the input signal voltage Vsig representing a video signal and the drain-source current Ids flowing through a driving transistor to be referred to in description of effects of threshold-voltage and mobility correction processes;

FIG. 10 is a diagram showing the circuit of a typical configuration of control means according to a first embodiment;

FIG. 11 is an explanatory diagram showing timing charts to be referred to in description of operations carried out by the control means according to the first embodiment;

FIG. 12 is a diagram showing the circuit of a typical configuration of control means according to a second embodiment;

FIG. 13 is an explanatory diagram showing timing charts to be referred to in description of operations carried out by the control means according to the second embodiment;

FIG. 14 is a diagram showing the circuit of a typical configuration of control means according to a third embodiment;

FIG. 15 is an explanatory diagram showing timing charts to be referred to in description of operations carried out by the control means according to the third embodiment;

FIG. 16 is a diagram showing a perspective view of a TV to which an embodiment according to the present invention is applied;

FIG. 17A is a diagram showing a perspective view of the front side of the digital camera to which an embodiment according to the present invention is applied;

FIG. 17B is a diagram showing a perspective view of the rear side of the digital camera to which an embodiment according to the present invention is applied;

FIG. 18 is a diagram showing a perspective view of a notebook personal computer to which an embodiment according to the present invention is applied;

FIG. 19 is a diagram showing a perspective view of a video camera to which an embodiment according to the present invention is applied;

FIG. 20A is a diagram showing the front face of a hand phone serving as the portable terminal to which an embodiment according to the present invention is applied;

FIG. 20B is a diagram showing a side face of the hand phone to which an embodiment according to the present invention is applied;

FIG. 20C is a diagram showing the front face of the hand phone in a folded state to which an embodiment according to the present invention is applied;

FIG. 20D is a diagram showing the left-side face of the hand phone in the folded state to which an embodiment according to the present invention is applied;

FIG. 20E is a diagram showing the right-side face of the hand phone in the folded state to which an embodiment according to the present invention is applied;

FIG. 20F is a diagram showing the top of the hand phone in the folded state to which an embodiment according to the present invention is applied; and

FIG. 20G is a diagram showing the bottom of the hand phone in the folded state to which an embodiment according to the present invention is applied.

### DETAILED DESCRIPTION OF THE PREFERRED EMBODIMENTS

Preferred embodiments of the present invention are described in detail by referring to diagrams as follows.

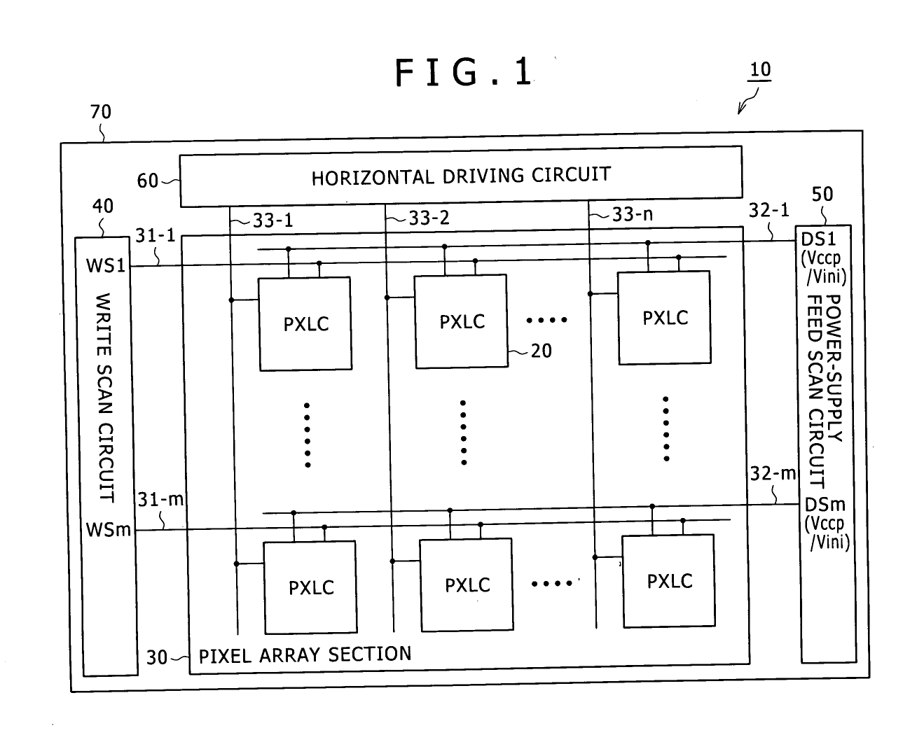

FIG. 1 is a system configuration diagram roughly showing the configuration of an active-matrix display apparatus according to an embodiment of the present invention. This typical configuration includes current-driven electro-optical devices each generating a light beam with the luminance thereof determined by a current flowing through the device. That is to say, the typical active-matrix display apparatus is an active-matrix organic EL display apparatus 10 employing light emitting devices each serving as the electro-optical device. An example of the light emitting device employed as the electro-optical device is an organic EL device.

As shown in FIG. 1, the organic EL display apparatus 10 according to the embodiment employs a pixel array section 30 including pixel circuits (PXLC) 20 laid out two-dimensionally to form a matrix and a driving section placed in the peripheries of the pixel array section 30 as a section for driving the pixel circuits 20. The driving section typically has a write scan circuit 40, a power-supply feed line scan circuit 50 and a horizontal driving circuit 60.

The pixel circuits 20 in the pixel array section 30 form a matrix of m rows and n columns. The m rows are connected to m scan lines 31-1 to 31-m respectively as well as m power-supply feed lines 32-1 to 32-m respectively. On the other hand, the n columns are connected to n signal lines 33-1 to 33-n respectively.

The pixel array section 30 is normally created on a transparent insulation substrate such as a glass substrate and has a panel (flat) structure. Each of the pixel circuits can be created by making use of an amorphous silicon TFT (Thin Film Transistor) or a low-temperature poly-silicon TFT. If a low-temperature poly-silicon TFT is used, the write scan circuit 40, the power-supply feed line scan circuit 50 and the horizontal driving circuit 60 are also created on a display panel (substrate) 70 on which the pixel array section 30 is created.

The write scan circuit 40 typically employs a shift register for shifting (transferring) start pulses sp synchronously with clock pulses ck. In order to carry out an operation to write a video signal into the pixel circuits 20 of the pixel array section 30, the write scan circuit 40 supplies sequential scan signals WS1 to WSm to the scan lines 31-1 to 31-m respectively in order to sequentially scan the pixel circuits 20 in row units in the so-called row sequential scan operation.

The power-supply feed line scan circuit 50 also typically employs a shift register for shifting (transferring) start pulses sp synchronously with clock pulses ck. The power-supply feed line scan circuit 50 supplies power-supply feed-line electric potentials DS1 to DSm to the power-supply feed lines 32-1 to 32-m respectively in synchronization with the row sequential scan operation carried out by the write scan circuit 40. The power-supply feed-line electric potentials DS1 to DSm are each switched to a high first electric potential Vccp from a low second electric potential Vini lower than the high first electric potential Vccp.

The horizontal driving circuit 60 properly selects the voltage Vsig representing a video signal or an offset voltage Vofs. The voltage Vsig representing a video signal varies in accordance with luminance information supplied by a signal supplying source (not shown in the figure). The horizontal driving circuit 60 then simultaneously supplies the selected voltage Vsig or Vofs to the pixel circuits 20 of the pixel array section 30 through signal lines 33-1 to 33-n typically in column units. That is to say, the horizontal driving circuit 60 supplies the input signal voltage Vsig (or the offset voltage Vofs) to all pixel circuits on a column simultaneously in the so-called write-line sequential write driving operation.

The offset voltage Vofs is a voltage serving as a reference of the voltage Vsig representing a video signal. Typically, the reference of the voltage Vsig representing a video signal corresponds to the black level of the video signal. In the following description, the voltage Vsig representing a video signal is also referred to as an input signal voltage Vsig or merely a signal voltage Vsig. In addition, the low second electric potential Vini is an electric potential sufficiently lower than the offset voltage Vofs.

### (Pixel Circuits)

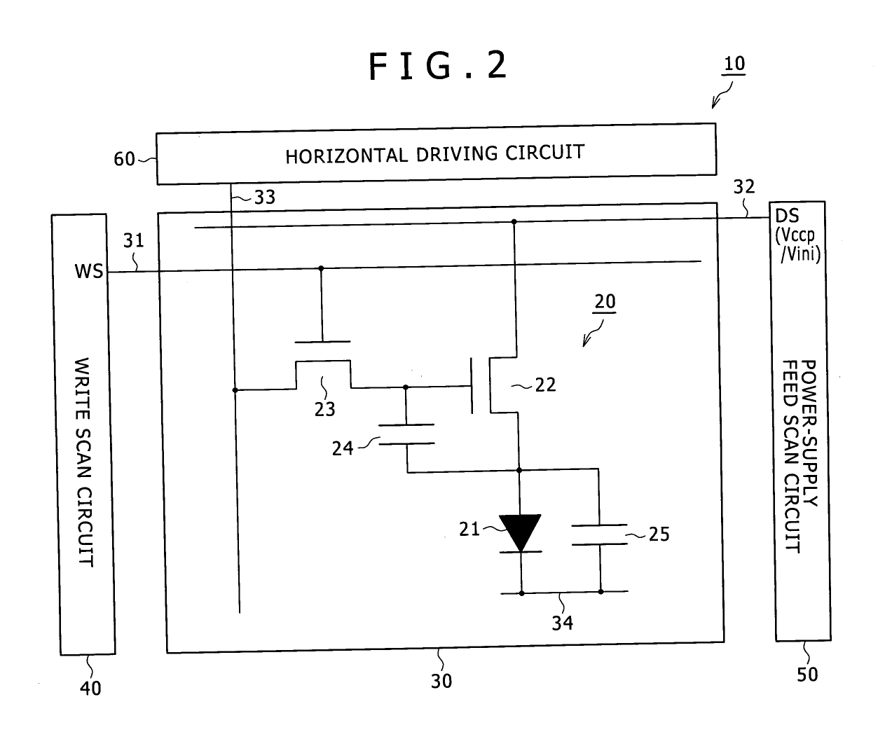

FIG. 2 is a circuit diagram showing a typical concrete configuration of a pixel (or a pixel circuit) 20. As shown in FIG. 2, the pixel circuit 20 employs an organic EL device 21 as a current-driven electro-optical device for generating a light beam with the luminance thereof determined by a current flowing through the device. In addition to the organic EL device 21, the pixel circuit 20 also employs a driving transistor 22, a write transistor 23, a voltage holding capacitor 24 and a supplementary capacitor 25.

In the above circuit, the driving transistor 22 and the write transistor 23 are each an N-channel TFT. However, the N-channel conduction type of the driving transistor 22 and the write transistor 23 is no more than a typical one. That is to say, the conduction type of the driving transistor 22 and the write transistor 23 is by no means limited to the N-channel conduction type.

The cathode of the organic EL device 21 is connected to a common power-supply feed line 34 which is connected to all pixel circuits 20. The source of the driving transistor 22 is connected to the anode of the organic EL device 21 and the drain of the driving transistor 22 is connected to a power-supply feed line 32 (or, to be more specific, the corresponding one of the power-supply feed lines 32-1 to 32-m).

The gate of the write transistor 23 is connected to a scan line 31 (or, to be more specific, the corresponding one of the scan lines 31-1 to 31-m). One of the source and drain of the write transistor 23 is connected to a signal line 33 (or, to be more specific, the corresponding one of the signal lines 33-1 to 33-n) whereas the other one of the source and drain of the write transistor 23 is connected to the gate of the driving transistor 22. One terminal of the voltage holding capacitor 24 is also connected to the gate of the driving transistor 22 whereas the other terminal of the voltage holding capacitor 24 is connected to the source of the driving transistor 22 as well as the anode of the organic EL device 21.

One terminal of the supplementary capacitor 25 is connected to the anode of the organic EL device 21 (or, that is, the source of the driving transistor 22) whereas the other terminal of the supplementary capacitor 25 is connected to the cathode of the organic EL device 21. As described above, the cathode of the organic EL device 21 is connected to the common power-supply feed line 34. The supplementary capacitor 25 connected to the organic EL device 21 to form a parallel circuit in this way plays a role of compensating the organic EL device 21 for a capacitance shortage of the organic EL device 21. Thus, the supplementary capacitor 25 is not an absolutely required component. That is to say, if the organic EL device 21 has a sufficient capacitance, the supplementary capacitor 25 can be omitted.

In the pixel circuit 20 with a configuration described above, when a scan signal WS generated by the write scan circuit 40 is applied to the gate of the write transistor 23 through a scan line 31, the write transistor 23 enters a conductive state. In this conductive state, the write transistor 23 samples the input signal voltage Vsig supplied by the horizontal driving circuit 60 through a signal line 33 as a video-signal voltage representing the luminance of a light beam or samples the offset voltage Vofs also supplied by the horizontal driving circuit 60 through the signal line 33 and writes the sampled voltage in the pixel circuit 20. To put it concretely, the write transistor 23 holds the sampled input signal voltage Vsig or the sampled offset voltage Vofs in the voltage holding capacitor 24.

With the electric potential DS of the power-supply feed line 32 (or, to be more specific, the corresponding one of the power-supply feed lines 32-1 to 32-m) set at the high first electric potential Vccp, the driving transistor 22 receives a current from the power-supply feed line 32 and supplies the current to the organic EL device 21 as a driving current for driving the organic EL device 21. The magnitude of the driving current is determined by the input signal voltage Vsig held in the voltage holding capacitor 24.

### (Pixel-Circuit Structure)

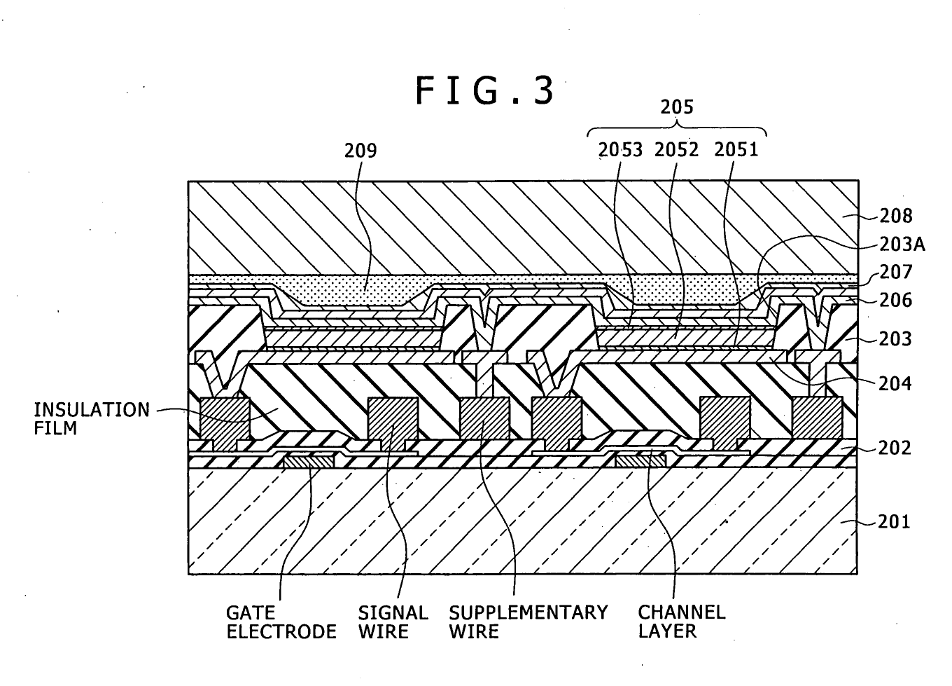

FIG. 3 is a diagram showing a typical cross-sectional structure of the pixel circuit 20. As shown in FIG. 3, the pixel circuit 20 is built into a configuration obtained by constructing an insulation film 202 and a wind insulation film 203 over a glass substrate 201 on which a pixel circuit 20 including a driving transistor 22 and a write transistor 23 has been created. The organic EL device 21 is provided in a dent 203A in the wind insulation film 203.

The organic EL device 21 has an anode electrode 204, an organic layer 205 and a cathode electrode 206. The anode electrode 204 is made of materials including a metal created on the bottom of the dent 203A of the wind insulation film 203. Created on the anode electrode 204, the organic layer 205 includes an electron transport layer 2053, a light emitting layer 2052 and a hole transport layer/hole injection layer 2051. Created on the organic layer 205, the cathode electrode 206 is made of materials including a transparent conductive film common to all pixel circuits 20.

The organic layer 205 of the organic EL device 21 is created by sequentially piling the hole transport layer/hole injection layer 2051, the light emitting layer 2052, the electron transport layer 2053 and an electron injection layer not shown in the figure to form a stacked pile of layers on the anode electrode 204. A current generated by the driving transistor 22, shown in FIG. 2 as a driving current, flows from the driving transistor 22 to the organic layer 205 through the anode electrode 204. As a result, the light emitting layer 2052 of the organic layer 205 generates light when a hole is recombined with an electron in the light emitting layer 2052.

After an organic EL device 21 is constructed over the glass substrate 201, on which a pixel circuit 20 including a driving transistor 22 and a write transistor 23 have been created, to sandwich the insulation film 202 and the wind insulation film 203 between the organic EL device 21 and the glass substrate 201 for each pixel circuit 20, a sealing substrate 208 is joined by an adhesive layer 209 to a passivation film 207. In this way, the sealing substrate 208 seals the organic EL device 21 to finally give a display panel 70.

### (Threshold-Voltage Correction Function)

While the horizontal driving circuit 60 is supplying the offset voltage Vofs to each of the signal lines 33 (that is, the signal lines 33-1 to 33-n) after the write transistor 23 has been put in the conductive state, the power-supply feed line scan circuit 50 switches the electric potential DS asserted thereby on the power-supply feed line 32 to the high first electric potential Vccp from the low second electric potential Vini. By switching the electric potential DS appearing on the power-supply feed line 32 to the high first electric potential Vccp from the low second electric potential Vini, a voltage corresponding to the threshold voltage Vth of the driving transistor 22 is held in the voltage holding capacitor 24.

The voltage corresponding to the threshold voltage Vth of the driving transistor 22 needs to be held in the voltage holding capacitor 24 because of the following reason. The characteristics of the driving transistor 22 vary from pixel to pixel due to variations of the process to fabricate the driving transistor 22 and due to characteristic changes with the lapse of time. The characteristics of the driving transistor 22 include the threshold voltage Vth and the mobility μ. The variations in transistor characteristics cause the driving current Ids flowing between the drain and source of the driving transistor 22 to vary from pixel to pixel even if the same electric potential is applied to the gates of the driving transistors 22 of the pixel circuits 20. Thus, the luminance of a light beam generated by the organic EL device 21 also varies from pixel to pixel. In order to cancel (or correct) effects of the variations of the threshold voltage Vth from pixel to pixel, a voltage corresponding to the threshold voltage Vth of the driving transistor 22 needs to be held in the voltage holding capacitor 24 in advance.

The threshold voltage Vth of the driving transistor 22 is corrected as follows. By storing a voltage corresponding to the threshold voltage Vth in the voltage holding capacitor 24 in advance, the threshold voltage Vth of the driving transistor 22 is cancelled by a voltage, which has been held in advance in the voltage holding capacitor 24 as the voltage corresponding to the threshold voltage Vth, in an operation to drive the driving transistor 22 by later applying the input signal voltage Vsig to the gate of the driving transistor 22 through the write transistor 23. In other words, the threshold voltage Vth of the driving transistor 22 is corrected in advance prior to the operation to drive the driving transistor 22 by applying the input signal voltage Vsig to the gate of the driving transistor 22 through the write transistor 23.

The function to hold a voltage corresponding to the threshold voltage Vth of the driving transistor 22 in the voltage holding capacitor 24 in advance is referred to as a threshold-voltage correction function. By carrying out this threshold-voltage correction function, effects of variations in threshold voltage Vth from pixel to pixel can be eliminated in case the threshold voltage Vth of the driving transistor 22 varies from pixel to pixel due to variations of the process to fabricate the driving transistor 22 and due to transistor-characteristic changes with the lapse of time. Thus, the luminance of a light beam generated by the organic EL device 21 can be sustained at a constant value. The principle of the threshold-voltage correction operation will be described later.

### (Mobility Correction Function)

The pixel circuit 20 shown in FIG. 2 is also provided with a mobility correction function in addition to the threshold-voltage correction function described above. The mobility correction function is carried out as follows. While the horizontal driving circuit 60 is supplying the input signal voltage Vsig to each of the signal lines 33 (that is, the signal lines 33-1 to 33-n) after the write transistor 23 has been put in the conductive state in response to one of the scan signals WS1 to WSm supplied by the write scan circuit 40 to the scan lines 31-1 to 31-m respectively, that is, during a mobility correction period, a mobility correction process is carried out in an operation to hold the input signal voltage Vsig in the voltage holding capacitor 24 as a process to eliminate dependence on the mobility μ of the driving current Ids flowing between the drain and source of the driving transistor 22. The concrete principle and concrete operation of the mobility correction function will be described later.

### (Bootstrap Function)

The pixel circuit 20 shown in FIG. 2 is further provided with a bootstrap function which works as follows. At a stage at which the input signal voltage Vsig has been held in the voltage holding capacitor 24, the write scan circuit 40 removes the scan signal WS (that is, the corresponding one of the scan signals WS1 to WSm) from the scan line 31 (that is, the corresponding one of the scan lines 31-1 to 31-m) in order to put the write transistor 23 in a non-conductive state. This non-conductive state electrically disconnects the gate of the driving transistor 22 from the signal line 33 (that is, the corresponding one of the signal lines 33-1 to 33-n) and puts the gate of the driving transistor 22 in a floating state.

With the gate of the driving transistor 22 put in a floating state, the voltage holding capacitor 24 is connected between the gate and source of the driving transistor 22 so that an electric potential Vg appearing on the gate will follow an electric potential Vs appearing on the source in an interlocked manner. Thus, the voltage Vgs appearing between the gate and source of the driving transistor 22 is ideally sustained at a constant value even if the electric potential Vs appearing on the source changes.

The operation to ideally sustain the voltage Vgs appearing between the gate and source of the driving transistor 22 at a constant value by letting the electric potential Vg appearing on the gate follow the electric potential Vs appearing on the source in an interlocked manner is referred to as a bootstrap operation. By carrying out this bootstrap operation, the luminance of a light beam generated by the organic EL device 21 can be maintained at a constant value even if the I-V characteristic of the organic EL device 21 changes with the lapse of time.

That is to say, even if the electric potential Vs appearing on the source of the driving transistor 22 changes due to the fact that the I-V characteristic of the organic EL device 21 changes with the lapse of time, execution of the bootstrap operation causes the voltage Vgs appearing between the gate and source of the driving transistor 22 to be sustained at a constant value. Thus, the driving current flowing through the organic EL device 21 does not vary. Accordingly, the luminance of a light beam generated by the organic EL device 21 can also be maintained at a constant value. As a result, even if the I-V characteristic of the organic EL device 21 changes with the lapse of time, it is possible to implement an image display without luminance deteriorations accompanying the changes in I-V characteristic.

### Characteristics of the Embodiment

In the case of an organic EL display apparatus 10 having at least the threshold-voltage correction function which is one of the threshold-voltage correction, mobility correction and bootstrap functions described above, the embodiment is characterized in that, in order to be capable of ideally carrying out a threshold-voltage correction operation, after a voltage corresponding to the threshold voltage Vth of the driving transistor 22 has been stored by the write transistor 23 in the voltage holding capacitor 24 prior to an operation carried out by the write transistor 23 to write the input signal voltage Vsig representing a video signal in the voltage holding capacitor 24, the power-supply feed line 32 (that is, the corresponding one of the power-supply feed lines 32-1 to 32-m) is put in a floating state during a period ending at a time not earlier than the start of the operation to write the input signal voltage Vsig. A concrete embodiment for putting the power-supply feed line 32 in a floating state will be described later.

### (Circuit Operations)

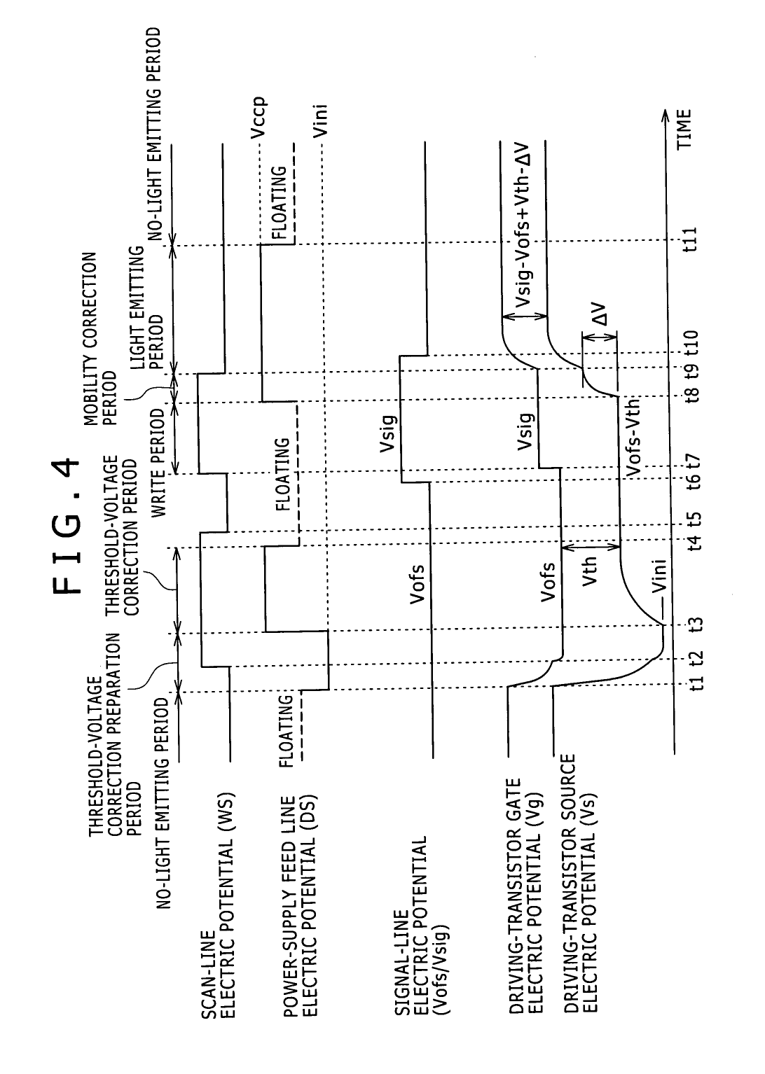

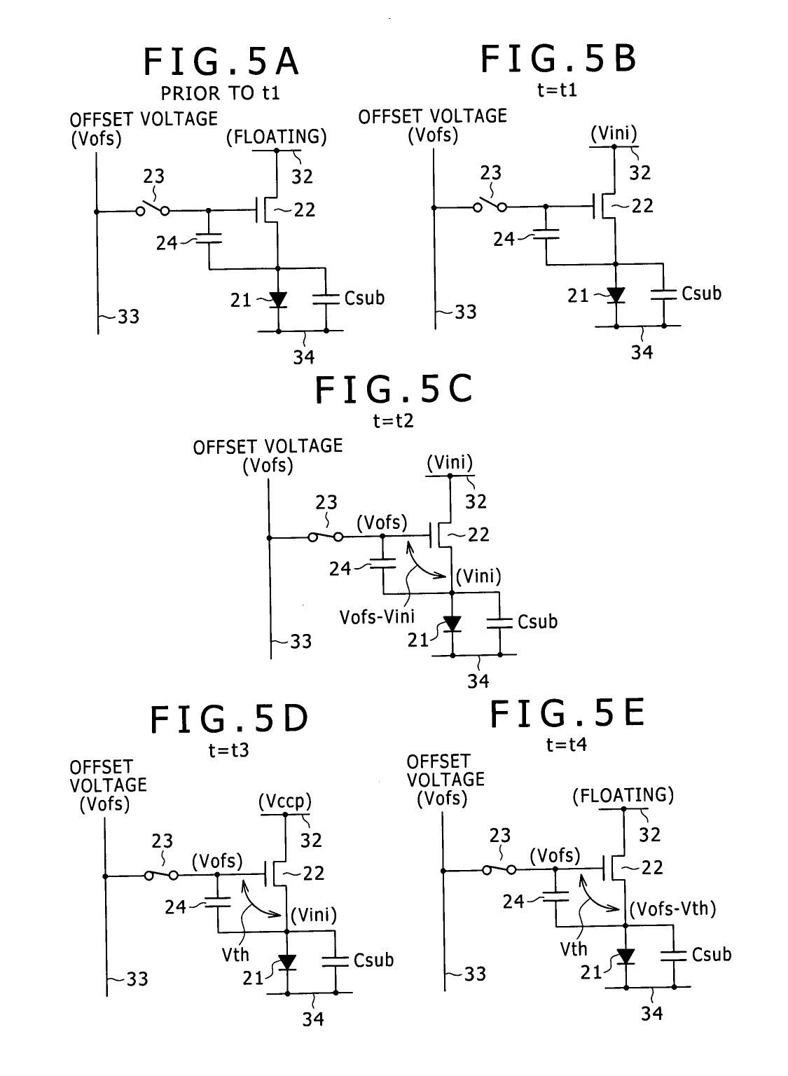

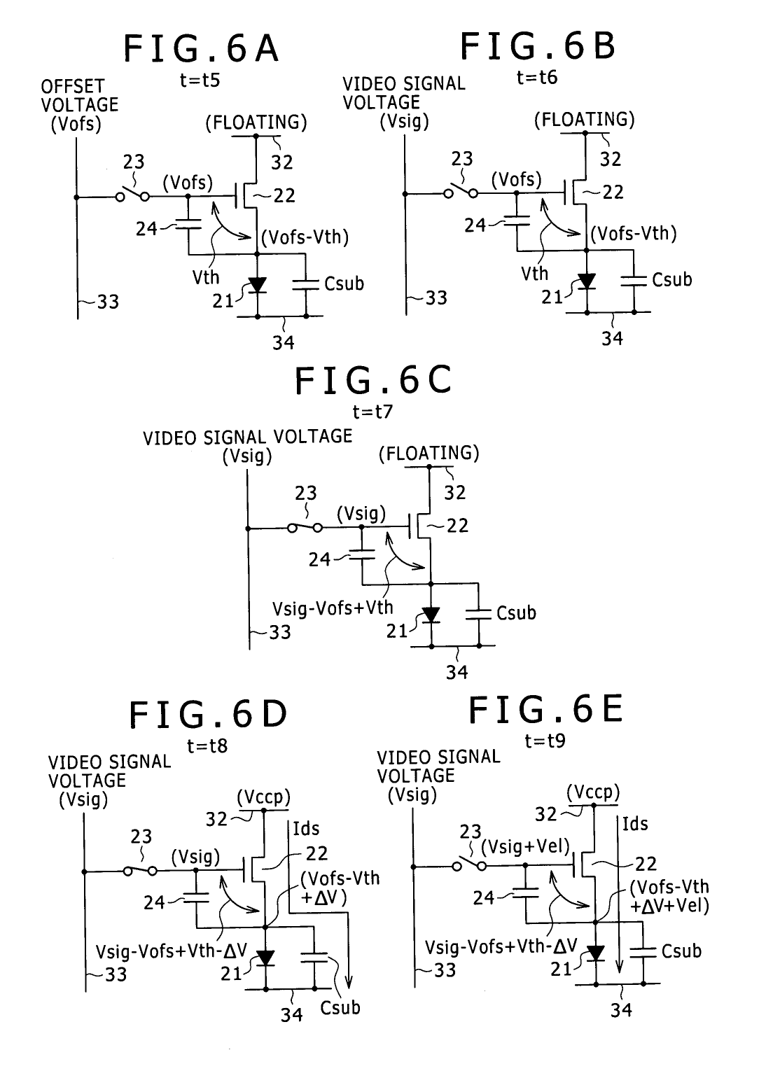

Operations carried out by the organic EL display apparatus 10 according to the embodiment are explained by referring to timing charts of FIG. 4 as well as explanatory operation diagrams of FIGS. 5A to 6E as follows. It is to be noted that, in order to make the explanatory operation diagrams of FIGS. 5A to 6E simple, the write transistor 23 is shown as a symbol representing a switch. In addition, capacitor Csub is shown in the diagrams as a compound capacitor representing the supplementary capacitor 25 and a parasitic capacitor of the organic EL device 21.

In the timing charts shown in FIG. 4, the horizontal axis is a time axis common to the charts. The timing charts show a variety of changes occurring along the time axis. The changes shown in the timing charts are changes of an electric potential representing the scan signal WS appearing on the scan line 31 representing the scan lines 31-1 to 31-m, changes of the electric potential DS appearing on the power-supply feed line 32 representing the power-supply feed lines 32-1 to 32-m, changes (from Vofs to Vsig and vice versa) of an electric potential appearing on the signal line 33 representing the signal lines 33-1 to 33-n, changes of the electric potential Vg appearing on the gate of the driving transistor 22 and changes of the electric potential Vs appearing on the source of the driving transistor 22.

### <No-Light Emitting Period>

Prior to a time t1 in the timing charts shown in FIG. 4, as shown in FIG. 5A, the power-supply feed line 32 is sustained in a floating state supplying no current to the driving transistor 22. Thus, the organic EL device 21 is sustained in a state of emitting no light.

### <Threshold-Voltage Correction Preparatory Period>

At the time t1, the pixel circuit 20 enters a new field of a row sequential scan process. At this time, the electric potential DS appearing on the power-supply feed line 32 is switched from the floating state to the low second electric potential Vini sufficiently lower than the offset voltage Vofs appearing on the signal line 33, as shown in FIG. 5B.

Let symbol Vel denote the threshold voltage of the organic EL device 21 and the notation Vcath denote an electric potential appearing on the common power-supply feed line 34. In addition, let us assume that the low second electric potential Vini satisfies a relation of Vini<(Vel+Vcath). In this case, since the electric potential Vs appearing on the source of the driving transistor 22 is approximately equal to the low second electric potential Vini, the organic EL device 21 is put in a reverse bias state.

Then, at a time t2, the electric potential WS appearing on the scan line 31 is changed from a low level to a high level in order to put the write transistor 23 in a conductive state, as shown in FIG. 5C. At that time, since the horizontal driving circuit 60 has supplied the offset voltage Vofs to the signal line 33, the electric potential Vg appearing at the gate of the driving transistor 22 is also set at the offset voltage Vofs as well. In addition, the electric potential Vs appearing on the source of the driving transistor 22 is set at the low second electric potential Vini which is sufficiently lower than the offset voltage Vofs.

Thus, the voltage Vgs appearing between the gate and source of the driving transistor 22 becomes equal to a difference of (Vofs−Vini). If the difference of (Vofs−Vini) is not greater than the threshold voltage Vth of the driving transistor 22, the threshold-voltage correction operation explained earlier cannot be carried out. It is thus necessary to set an electric-potential relation of (Vofs−Vini)>Vth. The operation to initialize the electric potential Vg appearing at the gate of the driving transistor 22 by fixing (or confirmedly setting) the electric potential Vg at the offset voltage Vofs and the operation to initialize the electric potential Vs appearing at the source of the driving transistor 22 by fixing (or confirmedly setting) the electric potential Vs at the low second electric potential Vini are referred to as a threshold-voltage correction preparatory operation.

### <Threshold-Voltage Correction Period>

Then, at a time t3, the electric potential DS appearing on the power-supply feed line 32 is changed from the low second electric potential Vini to the high first electric potential Vccp, as shown in FIG. 5D. At that time, the electric potential Vs appearing at the source of the driving transistor 22 starts to rise. In due course of time, the voltage Vgs appearing between the gate and source of the driving transistor 22 becomes equal to the threshold voltage Vth of the driving transistor 22, causing a voltage corresponding to the threshold voltage Vth of the driving transistor 22 to be held in the voltage holding capacitor 24.

Here, for the sake of convenience, a period during which a voltage corresponding to the threshold voltage Vth of the driving transistor 22 is held in the voltage holding capacitor 24 is referred to as a threshold-voltage correction period. It is to be noted that, in order to flow a current exclusively to the voltage holding capacitor 24 and no current to the organic EL device 21 during the threshold-voltage correction period, the organic EL device 21 needs to be put in a cutoff state by setting the common power-supply feed line 34 at the electric potential Vcath.

Then, at a time t4, the electric potential DS appearing on the power-supply feed line 32 is changed from the high first electric potential Vccp to a floating state, as shown in FIG. 5E, in order to end the threshold-voltage correction period.

Then, at a time t5, the electric potential WS appearing on the scan line 31 is changed from the high level to the low level in order to put the write transistor 23 in a non-conductive state, as shown in FIG. 6A. At this time, the gate of the driving transistor 22 is put in a floating state and, since the voltage Vgs appearing between the gate and source of the driving transistor 22 is approximately equal to the threshold voltage Vth of the driving transistor 22, the driving transistor 22 is put in a cutoff state. Thus, the drain-source current Ids does not flow through the driving transistor 22.

Then, at a time t6, the electric potential appearing on the signal line 33 is changed from the offset voltage Vofs to the input signal voltage Vsig representing the video signal, as shown in FIG. 6B.

### <Write Period>

Then, at a time t7, the electric potential WS appearing on the scan line 31 is changed from the low level to the high level in order to put the write transistor 23 in a conductive state, as shown in FIG. 6C. In this conductive state, the write transistor 23 samples the input signal voltage Vsig representing the video signal and writes the sampled input signal voltage Vsig into the pixel circuit 20 by storing the input signal voltage Vsig in the voltage holding capacitor 24. As a result of the operation carried out by the write transistor 23 to hold the input signal voltage Vsig in the voltage holding capacitor 24, the electric potential Vg appearing on the gate of the driving transistor 22 becomes equal to the input signal voltage Vsig.

### <Mobility Correction Period>

Then, at a time t8, the electric potential DS appearing on the power-supply feed line 32 is changed from the floating state to the high first electric potential Vccp, as shown in FIG. 6D. With the electric potential DS of the power-supply feed line 32 changed to the high first electric potential Vccp, a current according to the input signal voltage Vsig flows from the power-supply feed line 32 to the driving transistor 22.

In the operation to drive the driving transistor 22 with a current according to the input signal voltage Vsig, the threshold voltage Vth of the driving transistor 22 is cancelled by a voltage, which has been held in advance in the voltage holding capacitor 24 as a voltage corresponding to the threshold voltage Vth of the driving transistor 22 in the so-called threshold-voltage correction process. The principle of the so-called threshold-voltage correction process will be explained later.

At that time, since the organic EL device 21 is initially in a cutoff (high-impedance) state, a drain-source current Ids flowing from the power-supply feed line 32 to the driving transistor 22 in accordance with a voltage applied to the signal line 33 as the input signal voltage Vsig representing the video signal proceeds to the capacitor Csub connected in parallel to the organic EL device 21. That is to say, the process to electrically charge the capacitor Csub is started.

The process to electrically charge the capacitor Csub causes the electric potential Vs appearing on the source of the driving transistor 22 to rise with the lapse of time. At that time, variations of the threshold voltage Vth of the driving transistor 22 have already been corrected. However, the drain-source current Ids flowing through the driving transistor 22 is dependent on the mobility μ of the driving transistor 22.

In due course of time, the electric potential Vs appearing on the source of the driving transistor 22 rises to a level of (Vofs−Vth+ΔV), making the voltage Vgs appearing between the gate and source of the driving transistor 22 equal to (Vsig−Vofs+Vth−ΔV). That is to say, the level of (Vsig−Vofs+Vth−ΔV) at which the voltage Vgs appearing between the gate and source of the driving transistor 22 is set is a result of a negative feedback to subtract the increase ΔV of the electric potential Vs appearing on the source of the driving transistor 22 from a voltage (Vsig−Vofs+Vth) held by the voltage holding capacitor 24. In other words, the negative feedback works to electrically discharge the voltage holding capacitor 24. Thus, the increase ΔV in electric potential Vs is the feedback quantity of the negative feedback.

By feeding back a negative feedback quantity ΔV proportional to the drain-source current Ids flowing through the driving transistor 22 to the gate of the driving transistor 22, as described above, that is, by applying the negative feedback quantity ΔV to the voltage Vgs appearing between the gate and source of the driving transistor 22, the dependence of the drain-source current Ids flowing through the driving transistor 22 on the mobility μ is eliminated. That is to say, a mobility correction operation is carried out to correct the variations of the mobility μ.

To put it more concretely, the higher the input signal voltage Vsig representing the video signal is, the larger the drain-source current Ids flowing through the driving transistor 22 becomes and, hence, the larger the absolute value of the feedback quantity ΔV of the negative feedback becomes. In the following description, the feedback quantity ΔV of the negative feedback is also referred to as a correction quantity ΔV. Thus, the mobility correction operation is carried out in accordance with the level of the luminance of a light beam generated by the organic EL device 21. In addition, with the input signal voltage Vsig of the video signal kept at a constant value, the larger the mobility μ of the driving transistor 22 is, the larger the absolute value of the feedback quantity ΔV of the negative feedback becomes. Thus, variations of the mobility μ from pixel to pixel can be eliminated. The principle of the mobility correction operation will be explained later.

### <Light Emitting Period>

Then, at a time t9, the electric potential WS appearing on the scan line 31 is changed from a high level to a low level in order to put the write transistor 23 in a non-conductive state, as shown in FIG. 6E. In this state, the gate of the driving transistor 22 is disconnected from the signal line 33. At the same time, the drain-source current Ids starts to flow through the organic EL device 21 so that an electric potential appearing on the anode of the organic EL device 21 rises in accordance with the drain-source current Ids.

The increase of the electric potential appearing on the anode of the organic EL device 21 is no other than an increase of the electric potential Vs appearing on the source of the driving transistor 22. As the electric potential Vs appearing on the source of the driving transistor 22 rises, the electric potential Vg appearing on the gate of the driving transistor 22 also rises as well in an interlocked manner due to a bootstrap operation of the voltage holding capacitor 24. At that time, the increase of the electric potential Vg appearing on the gate of the driving transistor 22 is equal to the increase of the electric potential Vs appearing on the source of the driving transistor 22. Therefore, in a light emitting period, the voltage Vgs appearing between the gate and source of the driving transistor 22 is sustained at the level of (Vsig−Vofs+Vth−ΔV).

Then, at a time t10, the electric potential appearing on the signal line 33 changes from the input signal voltage Vsig representing the video signal to the offset voltage Vofs. Later on, at a time t11, the power-supply feed line 32 enters a floating state, stopping the operation to supply the drain-source current Ids from the power-supply feed line 32 to the driving transistor 22. At this time, the light emitting period is ended.

### (Principle of the Threshold-Voltage Correction)

The principle of an operation to correct the threshold voltage Vth of the driving transistor 22 is explained as follows. Designed to operate in a saturated region, the driving transistor 22 functions as a constant current source. Thus, the driving transistor 22 supplies a driving current Ids to the organic EL device 21. Also referred to hereafter as a drain-source current Ids, the driving current Ids has a fixed magnitude expressed by following Eq. (1).

Ids=(½)*μ(W/L)Cox(Vgs−Vth)² (1)

Notation W denotes the channel width of the driving transistor 22, notation L denotes the channel length of the driving transistor 22 and notation Cox denotes a gate capacity per unit area of the driving transistor 22.

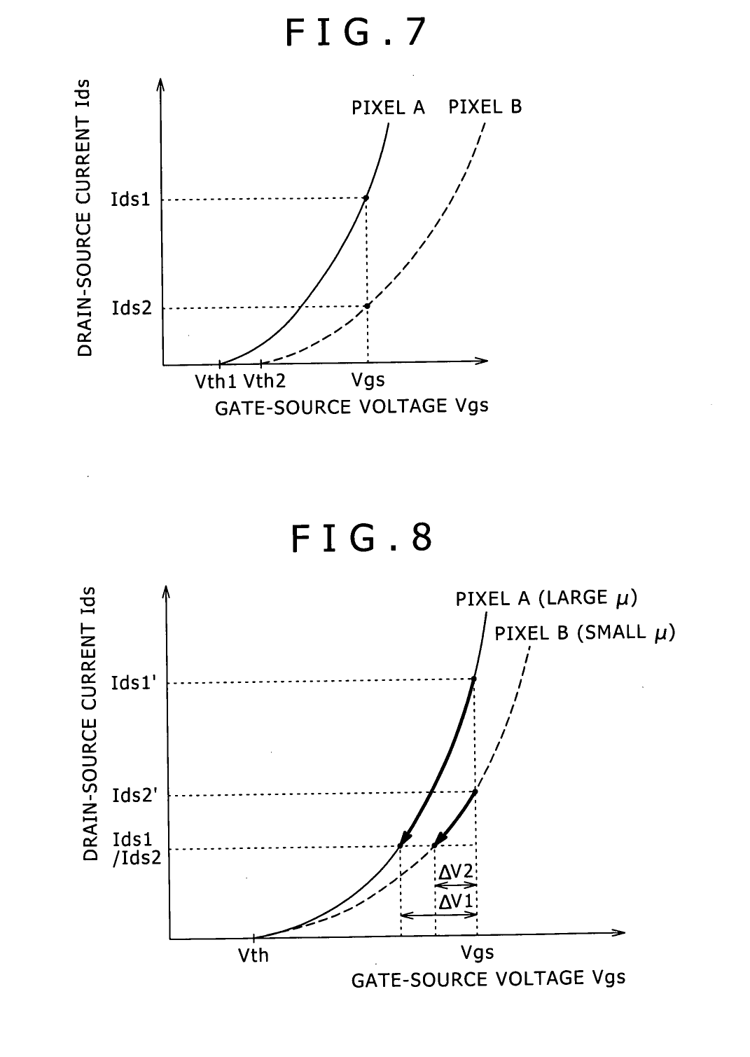

FIG. 7 is a diagram showing typical characteristic curves each representing a relation between the drain-source current Ids flowing through the driving transistor 22 and the gate-source voltage Vgs, which appears between the gate and source of the driving transistor 22. As described earlier, the threshold voltage Vth of the driving transistor 22 varies from pixel to pixel. In the case of the typical characteristic curves shown by the typical characteristic curves in the figure, the threshold voltage Vth of the driving transistor 22 in pixel circuit A is Vth1 whereas the threshold voltage Vth of the driving transistor 22 in pixel circuit B is Vth2 which is greater than Vth1 (that is, Vth2>Vth1). Thus, if a threshold-voltage correction operation is not carried out, for the same gate-source voltage Vgs appearing between the gate and source of the driving transistor 22, the driving transistor 22 of pixel circuit A generates a drain-source current Ids1 which is greater than a drain-source current Ids2 generated by the driving transistor 22 of pixel circuit B (that is, Ids2<Ids1). That is to say, if the threshold voltage Vth of a driving transistor 22 changes, the drain-source current Ids generated by the driving transistor 22 also changes even if the gate-source voltage Vgs applied between the gate and source of the driving transistor 22 remains the same.

In the case of the pixel (or the pixel circuit) 20 having the configuration described above, on the other hand, the gate-source voltage Vgs appearing between the gate and source of the driving transistor 22 is (Vsig−Vofs+Vth−ΔV), as described above. Inserting (Vsig−Vofs+Vth−ΔV) into Eq. (1) as a substitute for the gate-source voltage Vgs yields the following expression of the drain-source current Ids:

Ids=(½)*μ(W/L)Cox(Vsig−Vofs−ΔV)² (2)

That is to say, the term of the threshold voltage Vth of the driving transistor 22 is eliminated from Eq. (1) in a process referred to as the threshold-voltage correction operation to result in a drain-source current Ids expressed by Eq. (2). In other words, by virtue of the threshold-voltage correction operation, the drain-source current Ids supplied by the driving transistor 22 to the organic EL device 21 no longer depends on the threshold voltage Vth of the driving transistor 22. Thus, for a given gate-source voltage Vgs appearing between the gate and source, the drain-source current Ids does not change even if the threshold voltage Vth of the driving transistor 22 varies from pixel to pixel due to variations of the process to fabricate the driving transistor 22 and/or due to changes with the lapse of time. As a result, for a given gate-source voltage Vgs appearing between the gate and source, the organic EL device 21 generates a light beam with a luminance that does not vary from pixel to pixel and does not vary with the lapse of time.

### (Principle of the Mobility Correction)

Next, the principle of an operation to correct the mobility of the driving transistor 22 is explained as follows. FIG. 8 is a diagram showing typical characteristic curves each representing a relation between the drain-source current Ids flowing through the driving transistor 22 and the gate-source voltage Vgs, which appears between the gate and source of the driving transistor 22. As described earlier, the mobility μ of the driving transistor 22 varies from pixel to pixel. In the case of the typical characteristic curves shown by the typical characteristic curves in the figure, the mobility μ of the driving transistor 22 in pixel circuit A is greater than the mobility μ of the driving transistor 22 in pixel circuit B. If the driving transistor 22 is a poly-silicon thin film transistor, the pixel-to-pixel mobility variations such as the difference in mobility μ between pixel circuits A and B cannot be avoided.

If there is a difference in mobility μ of the driving transistor 22 between pixel circuits A and B, unless a process to correct the mobility μ in one way or another is carried out, the drain-source current Ids1′ flowing through the driving transistor 22 in pixel circuit A having a relatively large mobility μ of the driving transistor 22 is much greater than the drain-source current Ids2′ flowing through the driving transistor 22 in pixel circuit B having a relatively small mobility μ of the driving transistor 22 even if input signal voltages Vsig of the same level are applied to pixel circuits A and B. If the drain-source current Ids flowing in a pixel circuit is much different from the drain-source current Ids flowing in another pixel circuit due to mobility (μ) variations from pixel to pixel as described above, pixel-circuit uniformity is lost.

As is obvious from the transistor characteristic equation expressed by Eq. (1) given before, the larger the mobility μ is, the larger the drain-source current Ids becomes. Thus, the larger the mobility μ is, the larger the feedback quantity ΔV of the negative feedback becomes. As shown in FIG. 8, the feedback quantity ΔV1 of pixel circuit A having a driving transistor 22 with relatively large mobility μ is greater than the feedback quantity ΔV2 of pixel circuit B having a driving transistor 22 with a relatively small mobility μ. In a mobility correction process, the drain-source current Ids of the driving transistor 22 is negatively fed back to the side of the input signal voltage Vsig. In this negative feedback, the larger the mobility μ is, the larger the feedback quantity ΔV becomes. Thus, variations in mobility μ can be suppressed.

To put it concretely, if the mobility correction process making use of the feedback quantity ΔV1 is carried out on pixel circuit A having a driving transistor 22 with a relatively large mobility μ, the drain-source current Ids flowing through the driving transistor 22 is much reduced from the drain-source current Ids1′ to a drain-source current Ids1. If the mobility correction process making use of the feedback quantity ΔV2 is carried out on pixel circuit B having a driving transistor 22 with a relatively small mobility μ, on the other hand, the drain-source current Ids flowing through the driving transistor 22 is reduced from the drain-source current Ids2′ to a drain-source current Ids2 but the reduction of the drain-source current Ids is not so large as pixel circuit A. This is because the feedback quantity ΔV2 applied to pixel circuit B is smaller than the feedback quantity ΔV1 applied to pixel circuit A. As a result, the drain-source current Ids1 flowing through the driving transistor 22 of pixel circuit A becomes approximately equal to the drain-source current Ids2 flowing through the driving transistor 22 of pixel circuit B by virtue of the mobility correction process carried out on the mobility μ.

In sum, if pixel circuits A and B with different mobilities μ exist, the feedback quantity ΔV1 applied to pixel circuit A having a driving transistor 22 with a relatively large mobility μ is greater than the feedback quantity ΔV2 applied to pixel circuit B having a driving transistor 22 with a relatively small mobility μ. That is to say, the larger the mobility μ of a pixel circuit is, the larger the feedback quantity ΔV applied to the pixel circuit becomes and the larger the decrease in drain-source current Ids becomes. Thus, by negatively feeding the drain-source current Ids of the driving transistor 22 back to the side of the input signal voltage Vsig, the magnitudes of the drain-source currents Ids flowing through driving transistors 22 included in pixel circuits as transistors having different mobilities μ can be made uniform. As a result, variations in mobility μ can be eliminated in the mobility correction process.

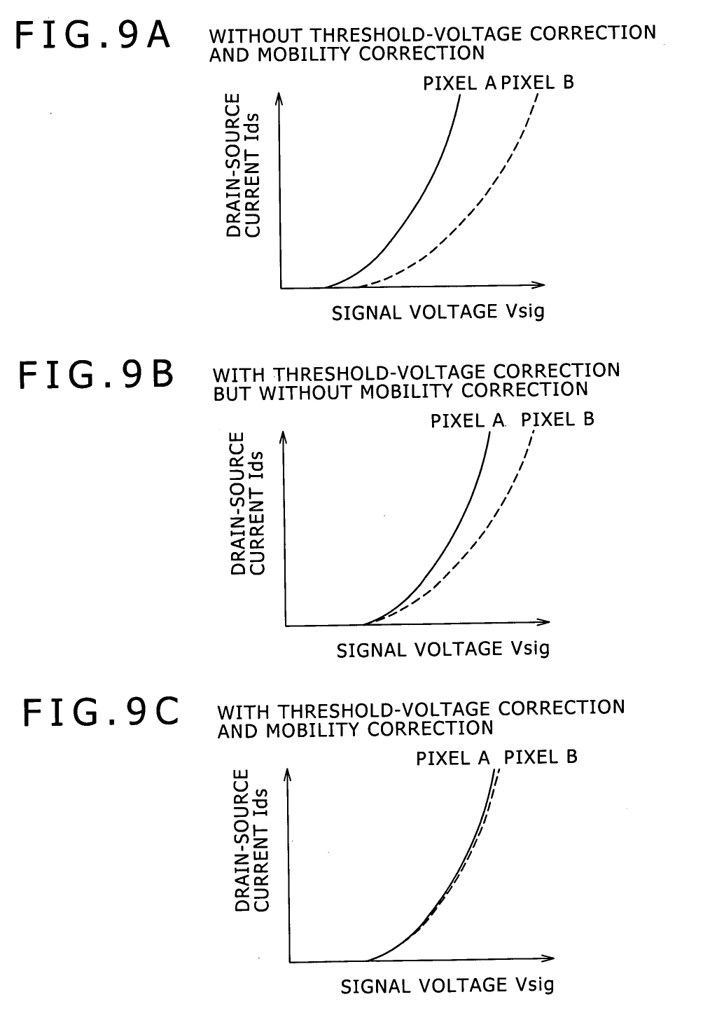

FIG. 9 is a plurality of diagrams each showing relations between the input signal voltage Vsig representing a video signal and the drain-source current Ids flowing through the driving transistor 22 in the pixel (or the pixel circuit) 20 shown in FIG. 2 for a variety of cases in which neither threshold-voltage correction operation nor mobility correction operation is carried out, the threshold-voltage correction operation is carried out but the mobility correction operation is not and both the threshold-voltage correction operation as well as the mobility correction operation are carried out.

To be more specific, FIG. 9A is a diagram showing relations between the input signal voltage Vsig representing a video signal and the drain-source current Ids flowing through the driving transistor 22 in pixel circuits A and B for a case in which neither threshold-voltage correction operation nor mobility correction operation is carried out. FIG. 9B is a diagram showing relations between the input signal voltage Vsig representing a video signal and the drain-source current Ids flowing through the driving transistor 22 in pixel circuits A and B for a case in which the threshold-voltage correction operation is carried out but the mobility correction operation is not. FIG. 9C is a diagram showing relations between the input signal voltage Vsig representing a video signal and the drain-source current Ids flowing through the driving transistor 22 in pixel circuits A and B for a case in which both the threshold-voltage correction operation and the mobility correction operation are carried out. For the case in which neither threshold-voltage correction operation nor mobility correction operation is carried out, for the same input signal voltage Vsig, the difference in drain-source current Ids between pixel circuits A and B is large, as shown in FIG. 9A, due to variations in threshold voltage Vth and mobility μ between pixel circuits A and B.

For the case in which the threshold-voltage correction operation is carried out, but the mobility correction operation is not, on the other hand, for the same input signal voltage Vsig, the difference in drain-source current Ids between pixel circuits A and B is reduced to a certain degree even though the difference still exists, as shown in FIG. 9B, mainly due to remaining variations in mobility μ between pixel circuits A and B. For the case in which both the threshold-voltage correction operation and the mobility correction operation are carried out, for the same input signal voltage Vsig, the difference in drain-source current Ids between pixel circuits A and B is all but zero, as shown in FIG. 9C, due to few remaining variations in threshold voltage Vth and mobility μ between pixel circuits A and B. Thus, at any gradation, luminance variations among organic EL devices 21 are not generated. As a result, a displayed image with a high quality can be obtained.

### Effects of the Embodiment

As described above, in an organic EL display apparatus 10 having at least the threshold-voltage correction function, after a voltage corresponding to the threshold voltage Vth of the driving transistor 22 has been held in the voltage holding capacitor 24 during a threshold-voltage correction period extended from the time t3 to the time t4 prior to an operation carried out by the write transistor 23 to write the input signal voltage Vsig representing a video signal into the pixel circuit 20, the power-supply feed line 32 is sustained in a floating state during a period ending at a time not earlier than the start of an operation to write the input signal voltage Vsig into the pixel circuit 20 to give the effects described below. To put it concretely, the electric potential DS appearing on the power-supply feed line 32 is sustained in a floating state during at least a period extended from the time t4 to the time t7 at which the operation to write the input signal voltage Vsig into the pixel circuit 20 is started. In the case of this embodiment, the power-supply feed line 32 is sustained in a floating state during a typical period extended from the time t4 to the time t8 later than the time t7.

Since the power-supply feed line 32 is sustained in a floating state during for example a typical period extended from the time t4 to the time t7, the power-supply feed line 32 does not supply a current to the driving transistor 22 during the period. Thus, a leak current does not flow to the driving transistor 22. Since a leak current does not flow to the driving transistor 22, the electric potential Vs appearing on the source of the driving transistor 22 does not fluctuate. As a result, the voltage Vgs appearing between the gate and source of the driving transistor 22 is sustained at a voltage held in the voltage holding capacitor 24 as a voltage corresponding to the threshold voltage Vth of the driving transistor 22.

Accordingly, in a subsequent voltage write process carried out by the write transistor 23 to hold a next input signal voltage Vsig representing the video signal in the voltage holding capacitor 24, a desired threshold-voltage correction process can be carried out with a high degree of reliability. In this case, the desired threshold-voltage correction process is an ideal process to have the threshold voltage Vth of the driving transistor 22 and a voltage held in advance in the voltage holding capacitor 24 as a voltage corresponding to the threshold voltage Vth cancel each other. It is thus possible to obtain a displayed image with a high quality not affected by variations in threshold voltage Vth from pixel to pixel because of the threshold-voltage variations, which are attributed to the process to fabricate the driving transistor 22 and due to characteristic changes with the lapse of time, can be eliminated.

Incidentally, in the case of an alternative configuration in which the driving transistor 22 is also used as a transistor for controlling the light emitting period/the no-light emitting period of the organic EL device 21, the electric potential DS appearing on the power-supply feed line 32 is switched from the high first electric potential Vccp to the low second electric potential Vini and vice versa. Thus, the electric potential DS appearing on the power-supply feed line 32 is generally fixed at either the high first electric potential Vccp or the low second electric potential Vini without being put in a floating state.

Thus, in the case of this alternative configuration, the power-supply feed line 32 is not put in a floating state during a period extended from the time t4 to the time t8. Instead, after a voltage corresponding to the threshold voltage Vth of the driving transistor 22 has been held in the voltage holding capacitor 24 in an operation carried out in a threshold-voltage correction period extended from the time t3 to the time t4, the electric potential DS appearing on the power-supply feed line 32 is fixed at the high first electric potential Vccp as it is and, at the time t7, an operation to write the input signal voltage Vsig is started. In the case of the alternative configuration, however, the following problem is raised.

If the electric potential DS appearing on the power-supply feed line 32 is fixed at the high first electric potential Vccp as it is after a voltage corresponding to the threshold voltage Vth of the driving transistor 22 has been held in the voltage holding capacitor 24 in an operation carried out in a threshold-voltage correction period extended from the time t3 to the time t4, a leak current flows to the driving transistor 22. Thus, the electric potential Vs appearing on the source of the driving transistor 22 rises by a quantity determined by the magnitude of the leak current. At that time, the write transistor 23 is in a non-conductive state putting the gate of the driving transistor 22 in a floating state. Thus, the electric potential Vg appearing on the gate of the driving transistor 22 also rises to follow the rising electric potential Vs appearing on the source of the driving transistor 22.

Since a parasitic capacitor exists between the gate of the write transistor 23 and the gate of the driving transistor 22, however, when the electric potential Vs appearing on the source of the driving transistor 22 rises, the electric potential Vg appearing on the gate of the driving transistor 22 increases by an amount smaller than the increase in electric potential Vs. Thus, the gate-source voltage Vgs appearing between the gate and source of the driving transistor 22 becomes smaller than the voltage corresponding to the threshold voltage Vth of the driving transistor 22.

If the gate-source voltage Vgs appearing between the gate and source of the driving transistor 22 is smaller than the voltage corresponding to the threshold voltage Vth of the driving transistor 22, as described above, that is, if the voltage held in the voltage holding capacitor 24 is smaller than the voltage corresponding to the threshold voltage Vth of the driving transistor 22, in an operation to hold the input signal voltage Vsig representing the video signal in the voltage holding capacitor 24 at the time t7, the voltage held in advance by the voltage holding capacitor 24 does not cancel the threshold voltage Vth of the driving transistor 22. Thus, an ideal threshold-voltage correction operation is not carried out normally.

As described above, when the electric potential Vs appearing on the source of the driving transistor 22 rises by a quantity determined by the magnitude of the leak current flowing through the driving transistor 22, the electric potential Vg appearing on the gate of the driving transistor 22 increases by an amount smaller than the increase in electric potential Vs due to an effect of the parasitic capacitor existing between the gate of the write transistor 23 and the gate of the driving transistor 22. It is to be noted that the electric potential Vg appearing on the gate of the driving transistor 22 can also be said to increase by an amount smaller than the increase in electric potential Vs in a bootstrap operation described earlier.

In the case of an ideal bootstrap operation, however, the electric potential Vg appearing on the gate of the driving transistor 22 should increase by an amount equal to the increase in electric potential Vs so as to sustain the gate-source voltage Vgs appearing between the gate and source of the driving transistor 22 at a fixed value.

In reality, there is no ideal bootstrap operation. Nevertheless, if the electric potential Vg appearing on the gate of the driving transistor 22 increases by an amount smaller than the increase in electric potential Vs in an actual bootstrap operation, the gate-source voltage Vgs appearing between the gate and source of the driving transistor 22 decreases, reducing the luminance of a light beam generated by the organic EL device 21 only a little bit. Thus, in comparison with the problem that the ideal threshold-voltage correction process cannot be carried out normally as described above, the decrease in electric potential Vgs in an actual bootstrap operation can be said to have almost no effect on the displayed image.

In the case of the embodiment, on the other hand, the power-supply feed line 32 is sustained in a floating state during a period extended from the time t4 to the time t8, as shown in the timing charts of FIG. 4, in order to prevent a leak current from flowing through the driving transistor 22. It is to be noted, however, that by merely sustaining the power-supply feed line 32 in a floating state during a period ending at the start of an operation to write the input signal voltage Vsig, that is, during the period extended from the time t4 to the time t7, the same result can still be achieved.

If the power-supply feed line 32 is sustained in a floating state during a period extended from the time t4 to the time t8, the period extended from the time t7 to the time t8 becomes a period to write the input signal voltage Vsig into the pixel circuit 20 whereas a period extended from the time t8 to the time t9 becomes a mobility correction period as is obvious from the timing charts shown in FIG. 4. That is to say, a period extended from the time t7 to the time t9 is divided into two periods, i.e., the period to write the input signal voltage Vsig into the pixel circuit 20 and the mobility correction period which immediately follows the period to write the input signal voltage Vsig into the pixel circuit 20.

By setting the mobility correction period immediately after the period to write the input signal voltage Vsig into the pixel circuit 20, as described above, a mobility correction operation is started after an operation to write the input signal voltage Vsig into the pixel circuit has been completely carried out. Thus, the mobility correction operation can be carried out in a stable manner. As a result, mobility variations from pixel to pixel can be eliminated to result in an improved image quality.

The embodiment described above implements an organic EL display apparatus 10 employing organic EL devices 21 each functioning as an electro-optical device in a pixel circuit 20. It is to be noted, however, that the scope of the present invention is by no means limited to the embodiment. That is to say, the present invention can be applied to any general display apparatus that employs current-driven electro-optical devices (also referred to as light emitting devices) each generating a light beam with the luminance thereof determined by a current following through the device.

### Other Embodiments

The following description explains concrete embodiments each implementing control means for sustaining the power-supply feed line 32 in a floating state during a period ending at a time not earlier than the start of the operation to write the input signal voltage Vsig into the pixel circuit 20, that is, during for example a typical period extended from the time t4 to the time t7, at which the operation to write the input signal voltage Vsig into the pixel circuit 20 is started, after a voltage corresponding to the threshold voltage Vth of the driving transistor 22 has been held in the voltage holding capacitor 24 during a threshold-voltage correction period extended from the time t3 to the time t4 prior to an operation carried out by the write transistor 23 to hold the input signal voltage Vsig representing a video signal in the voltage holding capacitor 24 employed in the pixel circuit 20 at the time t7. In the case of the embodiment described so far, the power-supply feed line 32 is sustained in a floating state during a typical period extended from the time t4 to the time t8, as shown in the timing charts of FIG. 4.

### First Embodiment

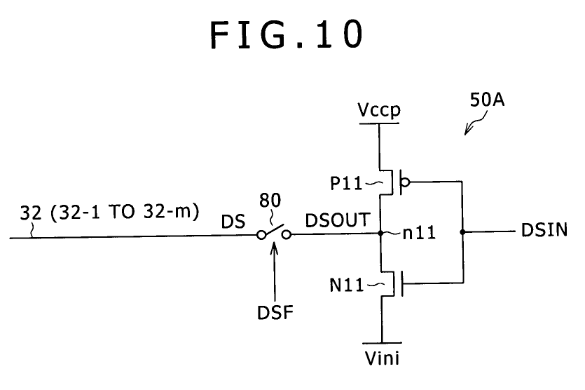

FIG. 10 is a diagram showing the circuit of a typical configuration of control means according to a first embodiment. As shown in the figure, the control means employs a last-stage buffer 50A connected to a power-supply feed line 32 (that is, any one of the power-supply feed lines 32-1 to 32-m). The last-stage buffer 50A is a portion included in the power-supply feed line scan circuit 50 as a portion connected to the power-supply feed line 32 which is connected to a pixel row of the pixel array section 30.

The last-stage buffer 50A has a CMOS inverter configuration including a P-channel MOS transistor P11 and an N-channel MOS transistor N11. The source of the P-channel MOS transistor P11 is connected to the power-supply line of the high first electric potential Vccp. The source of the N-channel MOS transistor N11 is connected to the power-supply line of the low second electric potential Vini. The drain of the P-channel MOS transistor P11 is connected to the drain of the N-channel MOS transistor N11 through a drain common connection node n11 whereas the gate of the P-channel MOS transistor P11 is connected to the gate of the N-channel MOS transistor N11.

In the last-stage buffer 50A, the gates of the P-channel MOS transistor P11 and the N-channel MOS transistor N11 receive scan pulses DSIN from a stage immediately preceding the last-stage buffer 50A. The drain common connection node n11 connecting the drains of the P-channel MOS transistor P11 and the N-channel MOS transistor N11 to each other serves as the output terminal of the last-stage buffer 50A as well as the output terminal of the power-supply feed line scan circuit 50. The drain common connection node n11 is connected to the power-supply feed line 32 through a switch device 80.

The control means for sustaining the power-supply feed line 32 in a floating state during the period extended from the time t4 to the time t8 also employs the switch device 80 for connecting the drain common connection node n11 to the power-supply feed line 32. Typically, the switch device 80 is an electronic switch such as a MOS switch or a CMOS transfer switch. The switch device 80 is put in an open or closed state in accordance with a control pulse DSF supplied to the switch device 80.

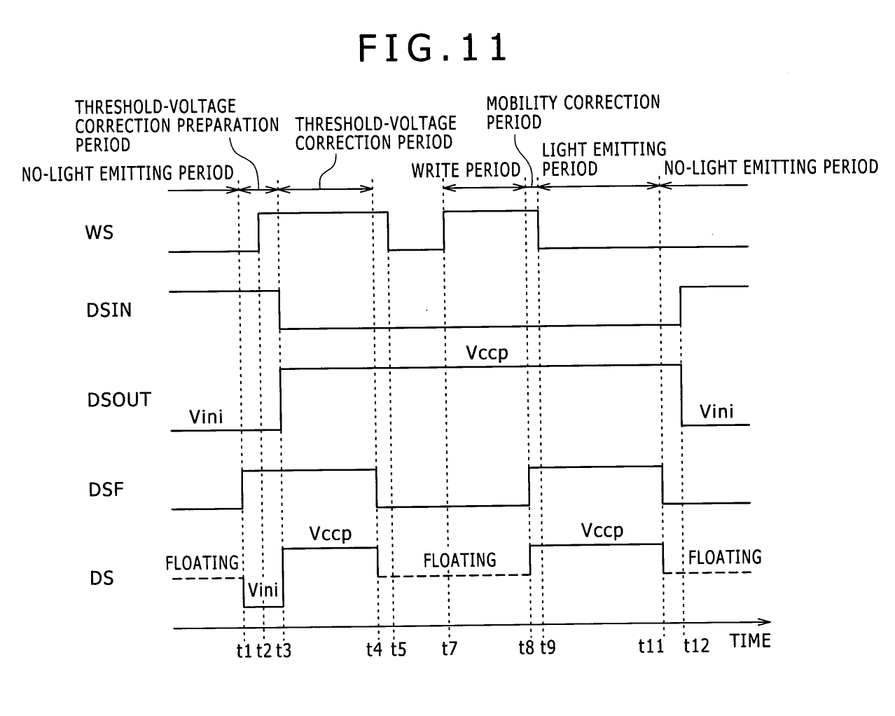

Next, the operation of the circuit according to the first embodiment is explained by referring to timing charts shown in FIG. 11. FIG. 11 is a diagram showing timing charts of the electric potential WS appearing on the scan line 31 connected to the pixel row, the scan pulses DSIN supplied to the last-stage buffer 50A, a power-supply electric potential DSOUT output by the last-stage buffer 50A, the control pulses DSF and the electric potential DS appearing on the power-supply feed line 32.

As shown in the timing charts of FIG. 11, the scan pulse DSIN is sustained at a high electric potential during a period ending at a time t3, a low electric potential during a period extended from the time t3 to a time t12 and back to the high electric potential during a period starting at the time t12. In the following description, the high electric potential and the low electric potential are referred to as an H level and an L level respectively.

On the other hand, the control pulse DSF is sustained at an H level during a period extended from a time t1 to a time t4 as well as a period extended from a time t8 to a time t11 and sustained at an L level during a period ending at the time t1, a period extended from the time t4 to the time t8 as well as a period starting at the time t11.

When the scan pulse DSIN is supplied to the last-stage buffer 50A, the last-stage buffer 50A generates the power-supply electric potential DSOUT which is sustained at the low second electric potential Vini during a period ending at the time t3, sustained at the high first electric potential Vccp during a period extended from the time t3 to the time t12 and restored back to the low second electric potential Vini during a period starting at the time t12.

In accordance with the control pulse DSF, the switch device 80 is sustained in an off state during a period ending at the time t1, a period extended from the time t4 to the time t8 and a period starting at the time t11. During these periods, the drain common connection node n11 serving as the output terminal of the last-stage buffer 50A is sustained in a state of being electrically disconnected from the power-supply feed line 32.

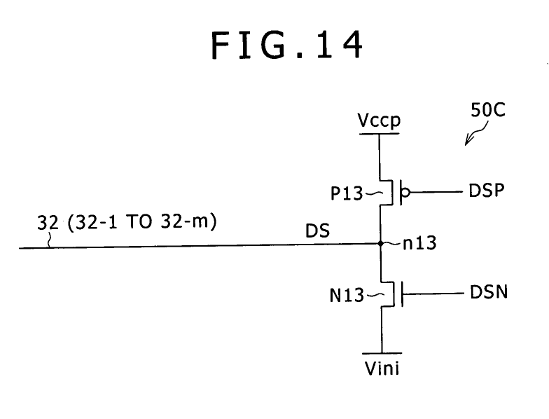

By operating the switch device 80, as described above, after a voltage corresponding to the threshold voltage Vth of the driving transistor 22 has been held in the voltage holding capacitor 24, the power-supply feed line 32 is sustained in a floating state during a period extended from the time t4 to the time t8 at which the period of an operation to write the input signal voltage Vsig into the pixel circuit 20 is ended, as shown in the timing charts of FIG. 14. As a result, in the operation to write the input signal voltage Vsig into the pixel circuit 20, an ideal threshold-voltage correction can be implemented.

It is to be noted that the control pulse DSF for turning the switch device 80 on and off can be generated as a result of logic processing carried out by a logic circuit, which is generally provided at a stage immediately following a shift register employed in the power-supply feed line scan circuit 50, by taking shift pulses output by the shift register as a reference.

### Second Embodiment

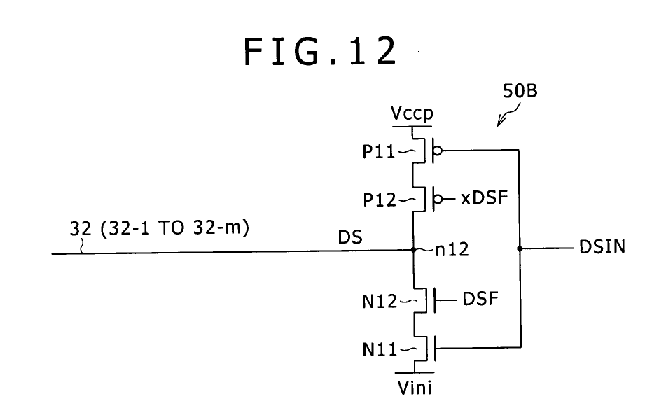

FIG. 12 is a diagram showing the circuit of a typical configuration of control means according to a second embodiment. Elements shown in FIG. 12 as elements identical with their respective counterparts shown in FIG. 10 are denoted by the same notations as the counterparts. As shown in FIG. 12, the control means employs a last-stage buffer 50B connected to a power-supply feed line 32 (that is, any one of the power-supply feed lines 32-1 to 32-m). The last-stage buffer 50B is a portion included in the power-supply feed line scan circuit 50 as a portion connected to the power-supply feed line 32 which is connected to a pixel row of the pixel array section 30.

The last-stage buffer 50B has a clocked inverter configuration including a P-channel MOS transistor P11, a P-channel MOS transistor P12, an N-channel MOS transistor N11 and an N-channel MOS transistor N12. The source of the P-channel MOS transistor P11 is connected to the power-supply line of the high first electric potential Vccp. The source of the N-channel MOS transistor N11 is connected to the power-supply line of the low second electric potential Vini. The drain of the P-channel MOS transistor P11 is connected to the source of the P-channel MOS transistor P12. The drain of the P-channel MOS transistor P12 is connected to the drain of the N-channel MOS transistor N12 through a drain common connection node n12 whereas the gate of the P-channel MOS transistor P11 is connected to the gate of the N-channel MOS transistor N11. The source of the N-channel MOS transistor N12 is connected to the drain of the N-channel MOS transistor N11.

In the last-stage buffer 50B, the gates of the P-channel MOS transistor P12 and the N-channel MOS transistor N12 receive scan pulses DSIN from a stage immediately preceding the last-stage buffer 50B. In addition, the gates of the P-channel MOS transistor P12 and the N-channel MOS transistor N12 receive control pulses xDSF and DSF respectively.

In the last-stage buffer 50B, the drain common connection node n12 connecting the drains of the P-channel MOS transistor P12 and the N-channel MOS transistor N12 to each other serves as the output terminal of the last-stage buffer 50B as well as the output terminal of the power-supply feed line scan circuit 50. The drain common connection node n12 is connected to the power-supply feed line 32. The N-channel MOS transistor N12 and the P-channel MOS transistor P12 function as control means to sustain the power-supply feed line 32 in a floating state during a period extended from a time t4 to a time t8.

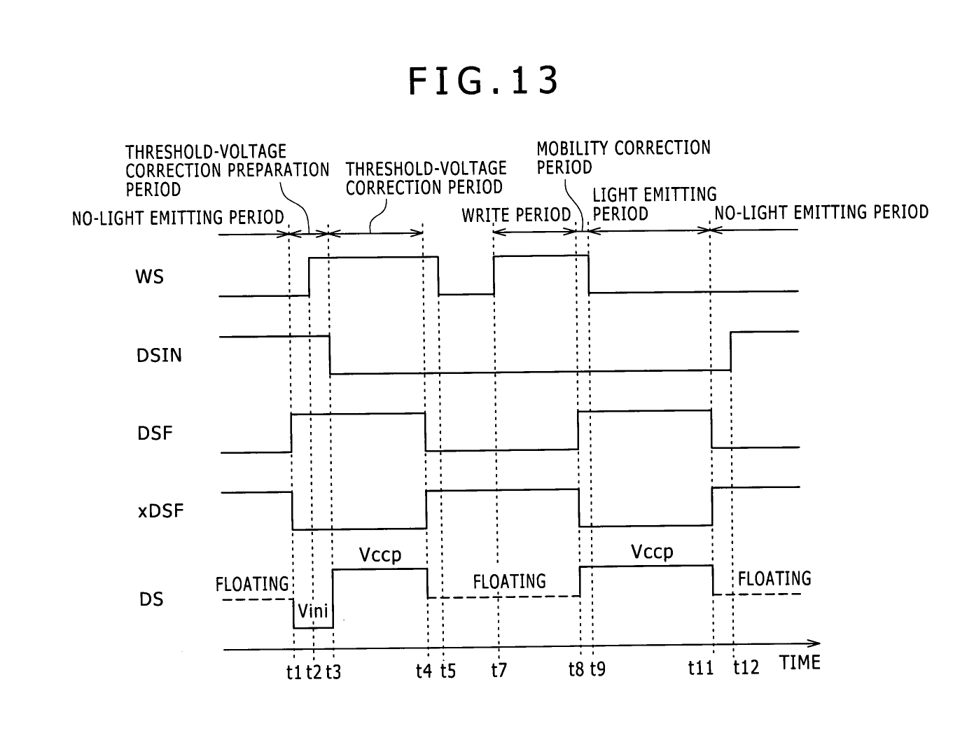

Next, the operation of the circuit according to the second embodiment is explained by referring to timing charts shown in FIG. 13. FIG. 13 is a diagram showing timing charts of the electric potential WS appearing on the scan line 31 connected to the pixel row, the scan pulses DSIN supplied to the last-stage buffer 50B, the control pulses DSF and xDSF as well as the electric potential DS appearing on the power-supply feed line 32.

As shown in the timing charts of FIG. 13, the scan pulse DSIN is sustained at an H level during a period ending at a time t3, sustained at an L level during a period extended from the time t3 to a time t12 and restored back to an H level during a period starting at the time t12.

The control pulse DSF is sustained at an H level during a period extended from a time t1 to a time t4 as well as a period extended from a time t8 to a time t11 and sustained at an L level during other periods. On the other hand, the control pulse xDSF is sustained at an L level during a period extended from the time t1 to the time t4 as well as a period extended from the time t8 to the time t11 and sustained at an H level during the other periods.

Since the scan pulse DSIN is set at an H level during the period ending at the time t3, the N-channel MOS transistor N11 is kept in a conductive state, outputting the low second electric potential Vini during the period. Since the control pulse DSF is sustained at an L level during a period ending at the time t1, however, the N-channel MOS transistor N12 is kept in a non-conductive state electrically disconnecting the N-channel MOS transistor N11 from the power-supply feed line 32 during the period.

During the period ending at the time t1, the P-channel MOS transistor P11 is also in a non-conductive state. Thus, the power-supply feed line 32 is sustained in a floating state during the period ending at the time t1. Then, at the time t1, the control pulse DSF is set at an H level in order to put the N-channel MOS transistor N12 in a conductive state. Thus, the N-channel MOS transistor N11 supplies the low second electric potential Vini to the power-supply feed line 32 by way of the N-channel MOS transistor N12.

During a period extended from the time t3 to a time t12, the scan pulse DSIN is sustained at an L level in order to keep the P-channel MOS transistor P11 in a conductive state which causes the P-channel MOS transistor P12 to output the high first electric potential Vccp. Since the control pulse xDSF is sustained at an H level during a period extended from the time t4 to the time t8, however, the P-channel MOS transistor P12 is kept in a non-conductive state electrically disconnecting the P-channel MOS transistor P11 from the power-supply feed line 32 during the period.

During the period extended from the time t4 to the time t8, the N-channel MOS transistor N11 is also in a non-conductive state. Thus, the power-supply feed line 32 is sustained in a floating state during the period extended from the time t4 to the time t8. During other periods, the P-channel MOS transistor P12 is kept in a conductive state. Thus, the P-channel MOS transistor P11 supplies the high first electric potential Vccp to the power-supply feed line 32 by way of the P-channel MOS transistor P12 during these other periods.

In the last-stage buffer 50B having the clocked inverter configuration described above, by virtue of the operations of the N-channel MOS transistor N12 and the P-channel MOS transistor P12, after a voltage corresponding to the threshold voltage Vth of the driving transistor 22 has been held in the voltage holding capacitor 24, the power-supply feed line 32 is sustained in a floating state during a period extended from the time t4 to the time t8 at which the period of an operation to write the input signal voltage Vsig into the pixel circuit 20 is ended, as shown in the timing charts of FIG. 13. As a result, in the operation to write the input signal voltage Vsig into the pixel circuit 20, an ideal threshold-voltage correction can be implemented.

It is to be noted that the control pulses DSF and xDSF supplied to the gates of the N-channel MOS transistor N12 and the P-channel MOS transistor P12 respectively can be generated as a result of logic processing carried out by a logic circuit, which is generally provided at a stage immediately following a shift register employed in the power-supply feed line scan circuit 50, by taking shift pulses output by the shift register as a reference.

### Third Embodiment

FIG. 14 is a diagram showing the circuit of a typical configuration of control means according to a third embodiment. As shown in the figure, the control means employs a last-stage buffer 50C connected to a power-supply feed line 32 (that is, any one of the power-supply feed lines 32-1 to 32-m). The last-stage buffer 50C is a portion included in the power-supply feed line scan circuit 50 as a portion connected to the power-supply feed line 32 which is connected to a pixel row of the pixel array section 30.

The last-stage buffer 50C has a two-phase input inverter configuration including a P-channel MOS transistor P13 and an N-channel MOS transistor N13. The source of the P-channel MOS transistor P13 is connected to the power-supply line of the high first electric potential Vccp. The source of the N-channel MOS transistor N13 is connected to the power-supply line of the low second electric potential Vini. The drain of the P-channel MOS transistor P13 is connected to the drain of the N-channel MOS transistor N13 through a drain common connection node n13. Scan pulses DSP are supplied to the gate of the P-channel MOS transistor P13 whereas scan pulses DSN having a phase different from the phase of the scan pulses DSP are supplied to the gate of the N-channel MOS transistor N13.

In the last-stage buffer 50C, the drain common connection node n13 connecting the drains of the P-channel MOS transistor P13 and the N-channel MOS transistor N13 to each other serves as the output terminal of the last-stage buffer 50C as well as the output terminal of the power-supply feed line scan circuit 50. The drain common connection node n13 is connected to the power-supply feed line 32.

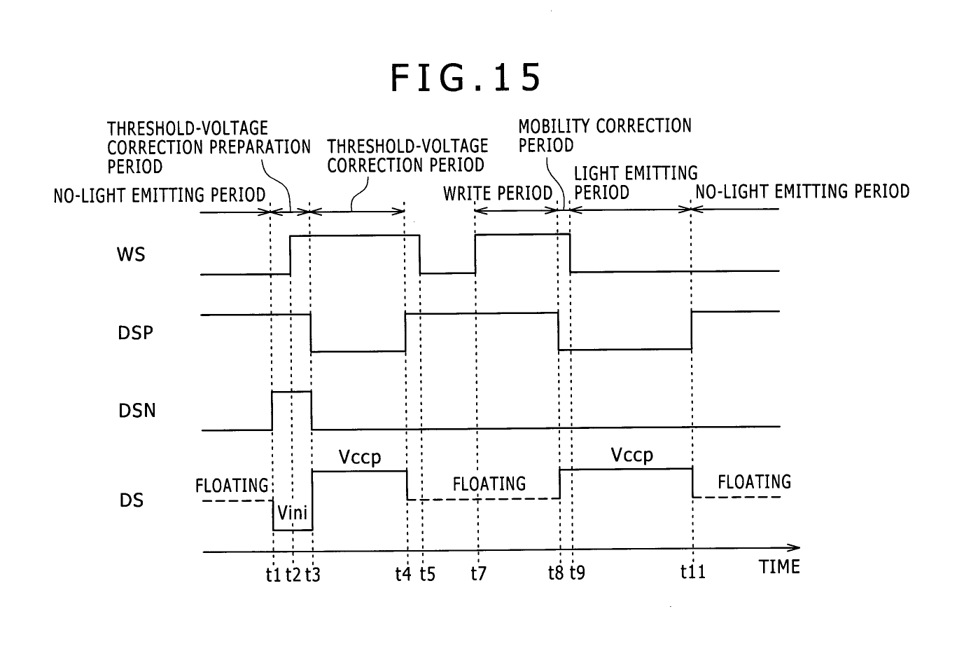

The relation between the phases of the scan pulses DSP and DSN is shown in the timing charts of FIG. 15. As shown in the figure, the scan pulse DSP is sustained at an H level during a period ending at a time t3, a period extended from a time t4 to a time t8 as well as a period starting at a time t11 and sustained at an L during a period extended from the time t3 to the time t4 as well as a period extended from the time t8 to the time t11. On the other hand, the scan pulse DSN is sustained at an H level during a period extended from a time t1 to the time t3 and sustained an L level during other periods.

Next, the operation of the circuit according to the third embodiment is explained by referring to timing charts shown in FIG. 15. FIG. 15 is a diagram showing timing charts of the electric potential WS appearing on the scan line 31 connected to the pixel row, the scan pulses DSP and DSN supplied to the last-stage buffer 50C as scan pulses with phases different from each other as well as the electric potential DS appearing on the power-supply feed line 32.

During a period ending at the time t1, the scan pulse DSP is sustained at an H level whereas the scan pulse DSN is sustained at an L level. Thus, both the P-channel MOS transistor P13 and the N-channel MOS transistor N13 are kept in a non-conductive state. As a result, the drain common connection node n13 and the power-supply feed line 32 connected to the drain common connection node n13 are sustained in a floating state in this period.

During the period extended from the time t1 to the time t3, the scan pulse DSN is sustained at an H level in order to keep the N-channel MOS transistor N13 in a conductive state. Thus, the low second electric potential Vini is supplied to the power-supply feed line 32 by way of the drain common connection node n13 in this period.

During the period extended from the time t3 to the time t4, both the scan pulse DSN and the scan pulse DSP are sustained at an L level in order to keep the N-channel MOS transistor N13 in a non-conductive state but the P-channel MOS transistor P13 in a conductive state. Thus, the high first electric potential Vccp is supplied to the power-supply feed line 32 by way of the drain common connection node n13 in this period.

During the period extended from the time t4 to the time t8, the scan pulse DSP is sustained at an H level but the scan pulse DSN is sustained at an L level in order to keep both the N-channel MOS transistor N13 and the P-channel MOS transistor P13 in a non-conductive state. Thus, the power-supply feed line 32 is sustained in a floating period in this period.

During the period extended from the time t8 to the time t11, both the scan pulse DSN and the scan pulse DSP are sustained at an L level in order to keep the N-channel MOS transistor N13 in a non-conductive state but the P-channel MOS transistor P13 in a conductive state. Thus, the high first electric potential Vccp is supplied to the power-supply feed line 32 by way of the drain common connection node n13 in this period.

During the period starting at the time t11, the scan pulse DSP is sustained at an H level but the scan pulse DSN is sustained at an L level in order to keep both the N-channel MOS transistor N13 and the P-channel MOS transistor P13 in a non-conductive state. Thus, the power-supply feed line 32 is sustained in a floating period in this period.

As is obvious from the above description, the N-channel MOS transistor N13 and the P-channel MOS transistor P13, which compose the last-stage buffer 50C, function as control means to sustain the power-supply feed line 32 in a floating state during the period extended from the time t4 to the time t8.

In addition, the scan pulses DSP and DSN with phases different from each other are supplied to the gates of the P-channel MOS transistor P13 and the N-channel MOS transistor N13 respectively in order to properly switch the electric potential DS appearing on the power-supply feed line 32 (that is, a corresponding one of the power-supply feed lines 32-1 to 32-m) from the high first electric potential Vccp to the low second electric potential Vini and vice versa in synchronization with the scanning operation carried out by the power-supply feed line scan circuit 50. On top of that, the scan pulses DSP and DSN also function as control pulses for sustaining the power-supply feed line 32 in a floating state during the period extended from the time t4 to the time t8.

As described above, in the last-stage buffer 50C having the two-phase inverter configuration described above, by virtue of the operations of the N-channel MOS transistor N13 and the P-channel MOS transistor P13, after a voltage corresponding to the threshold voltage Vth of the driving transistor 22 has been held in the voltage holding capacitor 24, the power-supply feed line 32 is sustained in a floating state during a period extended from the time t4 to the time t8 at which the period of an operation to write the input signal voltage Vsig into the pixel circuit 20 is ended, as shown in the timing charts of FIG. 15. As a result, in the operation to write the input signal voltage Vsig into the pixel circuit 20, an ideal threshold-voltage correction can be implemented.

It is to be noted that the scan pulses DSN and DSP supplied to the gates of the N-channel MOS transistor N13 and the P-channel MOS transistor P13 respectively as scan pulses having phases different from each other can be generated as a result of logic processing carried out by a logic circuit, which is generally provided at a stage immediately following a shift register employed in the power-supply feed line scan circuit 50, by taking shift pulses output by the shift register as a reference.

### [Typical Applications]

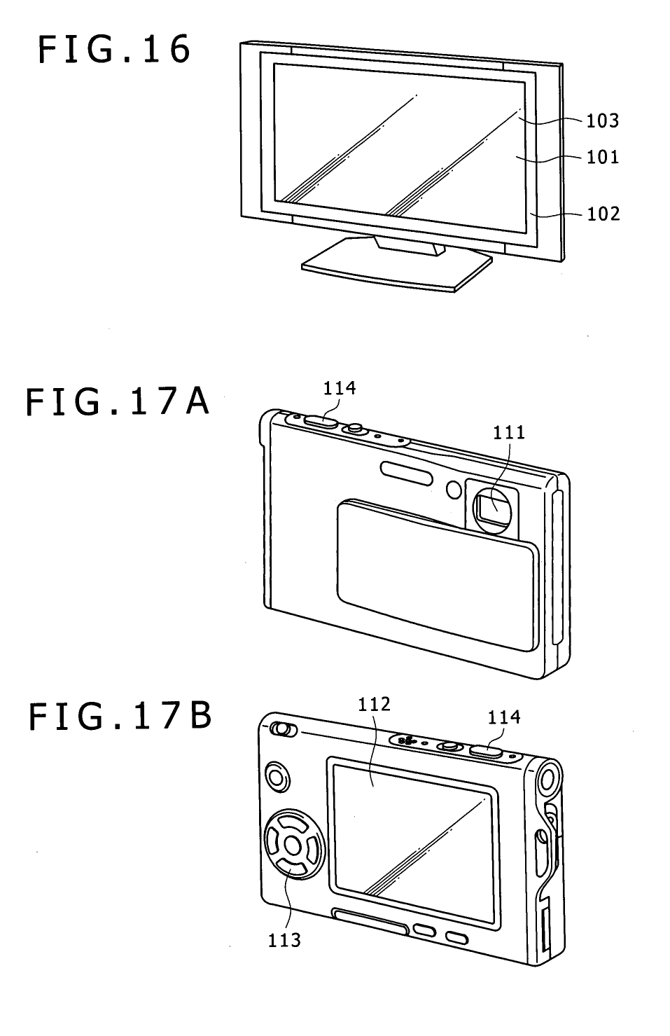

The display apparatus according to the embodiments described above are typically applied to various kinds of electronic equipment shown in FIGS. 16 to 20. To be more specific, the display apparatus can be used as the display apparatus employed in electronic equipment used in all fields as equipment for displaying a video signal supplied to the equipment or a video signal generated in the equipment on the display apparatus as an image or a video. Examples of the electronic equipment are a digital camera, a notebook personal computer, a portable terminal such as a hand phone and a video camera.

As described above, the display apparatus according to the present invention has a configuration in which the driving transistor also functions as a transistor for controlling the light emitting period/no-light emitting period of the electro-optical device and the light emitting period/no-light emitting period is controlled by switching the power-supply electric potential supplied to the driving transistor from a high level to a low level and vice versa. With such a configuration, the desired threshold-voltage correction process can be carried out with a high degree of reliability. In other words, the configuration allows the desired threshold-voltage correction process to be carried out in an ideal manner. Thus, the display apparatus has a merit given by the capability of displaying an image having a high quality. Typical pieces of electronic equipment to which embodiments of the present invention is applied are described as follows.

It is to be noted that the display apparatuses according to the present invention include a display apparatus having a sealed module configuration. In a typical sealed module configuration, a display module pasted to an opposed member such as a piece of transparent glass corresponds to the pixel array section 30. On the opposed transparent member, it is also possible to provide a color filter, a protection film, a light shielding film described earlier and another component. It is also worth noting that, on the display module, it is possible to provide a circuit or an FPC (Flexible Printed Circuit). The circuit is used for inputting a signal from an external source and supplying the signal to the pixel array section 30 and used for outputting a signal received from the pixel array section 30 to an external target.

FIG. 16 is a diagram showing a perspective view of a TV to which an embodiment of the present invention is applied. As shown in the figure, the TV serving as a typical application of the embodiment employs sections such as a video display screen 101 including a front panel 102 and a filter glass 103. In the TV, the display apparatus according to the present invention is used as the video display screen 101.

FIGS. 17A and 17B are diagrams showing perspective views of a digital camera to which an embodiment of the present invention is applied. To be more specific, FIG. 17A is a diagram showing a perspective view of the front side whereas FIG. 17B is a diagram showing a perspective view of the rear side. As shown in the figure, the digital camera according to the embodiment employs sections such as a light emitting section 111, a display section 112, a menu switch 113 and a shutter button 114. In the digital camera, the display apparatus according to the present invention is used as the display section 112.

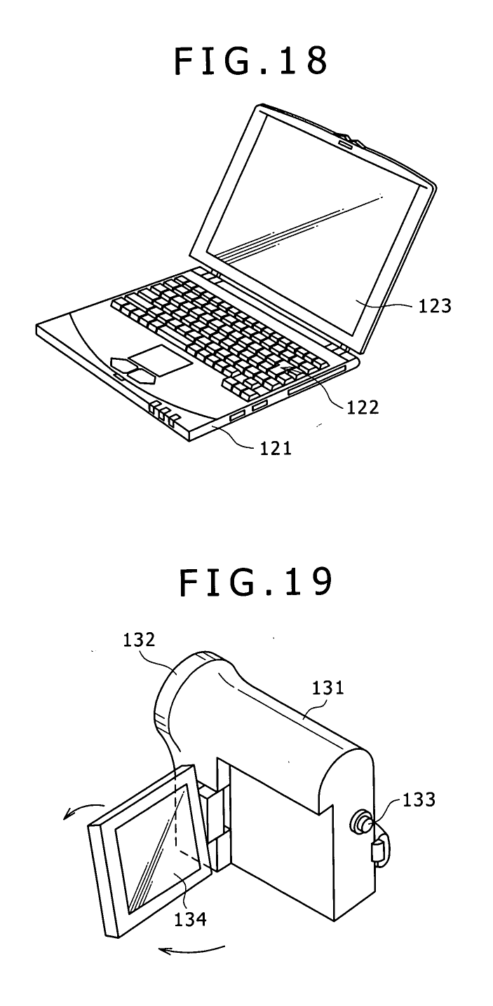

FIG. 18 is a diagram showing a perspective view of a notebook personal computer to which an embodiment of the present invention is applied. As shown in the figure, the main body 121 of the notebook personal computer according to the embodiment includes sections such as a keyboard 122 and a display section 123. The keyboard 122 is a section to be operated by the user to enter an input such as a string of characters whereas the display section 123 is a section for displaying an image. In the notebook personal computer, the display apparatus according to the present invention is used as the display section 123.

FIG. 19 is a diagram showing a perspective view of a video camera to which an embodiment of the present invention is applied. As shown in the figure, the main body 131 of the video camera according to the embodiment includes sections such as a lens 132, a start/stop switch 133 and a display section 134. In the video camera, the display apparatus according to the present invention is used as the display section 134.

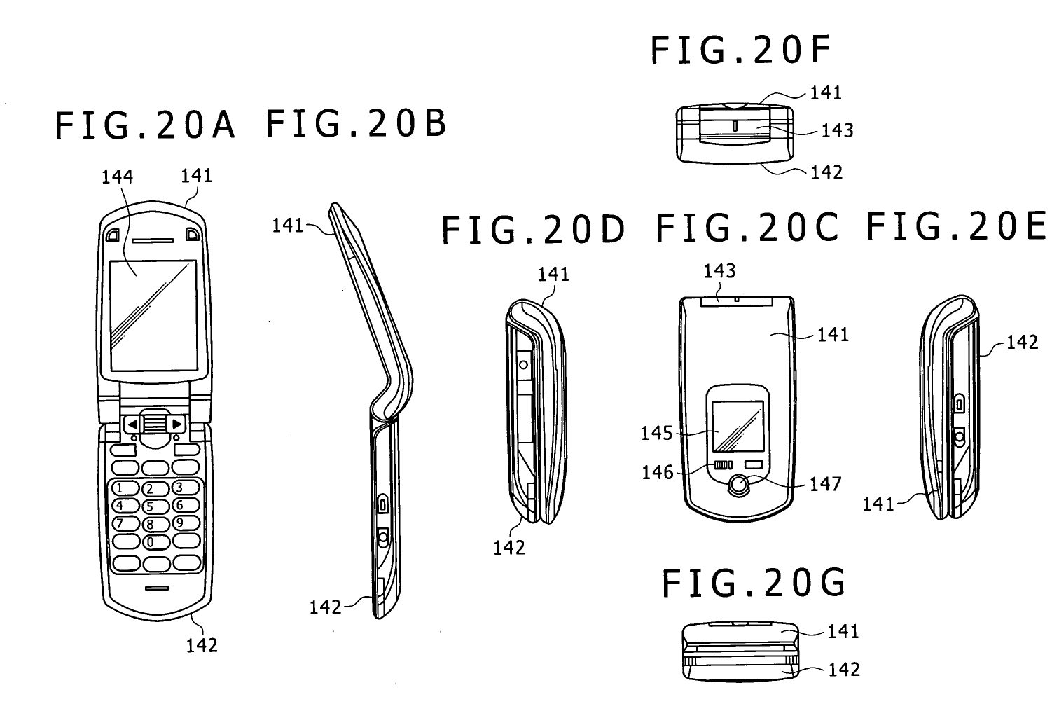

FIGS. 20A to 20G are diagrams showing perspective views of a portable terminal to which an embodiment of the present invention is applied. An example of the portable terminal is a hand phone. To be more specific, FIG. 20A is a diagram showing the front face of the hand phone whereas FIG. 20B is a diagram showing a side face of the phone. FIG. 20C is a diagram showing the front face of the hand phone in a folded state whereas FIG. 20D is a diagram showing the left-side face of the phone in the folded state. FIG. 20E is a diagram showing the right-side face of the hand phone in the folded state whereas FIG. 20F is a diagram showing the top of the phone in the folded state. FIG. 20G is a diagram showing the bottom of the hand phone in the folded state. As shown in the figure, the hand phone according to the embodiment employs sections such as an upper chassis 141, a lower chassis 142, a link section (or a hinge section) 143, a display section 144, a sub-display section 145, a picture light 146 and a camera 147. In the hand phone, the display apparatus according to the present invention is used as the display section 144 and the sub-display section 145.

In addition, it should be understood by those skilled in the art that a variety of modifications, combinations, sub-combinations and alterations may occur, depending on design requirements and other factors insofar as they are within the scope of the appended claims or the equivalents thereof.

What is claimed is:

1. A display apparatus comprising:
a pixel array section including pixel circuits laid out to form a matrix as pixel circuits each having
an electro-optical device,
a write transistor configured to carry out a voltage storing process to sample a video signal and store said sampled video signal into said pixel circuit,
a holding capacitor configured to hold said sampled video signal stored in said pixel circuit by said write transistor, and
a driving transistor configured to drive said electro-optical device on the basis of said video signal held by said holding capacitor;
first scan means connected to rows of said pixel circuits in said pixel array section for carrying out a selective scan operation on said pixel circuits in said pixel array section in row units and driving each of said write transistors to carry out said voltage storing process;
second scan means connected to said rows of said pixel circuits in said pixel array section for selectively supplying either a first electric potential or a second electric potential lower than said first electric potential synchronously with said selective scan operation carried out by said first scan means to power-supply feed lines for feeding a current to each of said driving transistors; and
control means for sustaining said power-supply feed line in a floating state during a period ending at a time not earlier than the start of said voltage storing process carried out by said write transistor to store said video signal in said holding capacitor after a voltage corresponding to the threshold voltage of said driving transistor has been held in said holding capacitor prior to said voltage storing process.

2. The display apparatus according to claim 1 wherein said control means electrically disconnects a power-supply line for providing said first electric potential and a power-supply line for providing said second electric potential from said power-supply feed line.

3. The display apparatus according to claim 2 wherein said control means is a switch device connected between the output terminal of said second scan means and said power-supply feed line.

4. The display apparatus according to claim 2 wherein:
said second scan means has a last-stage buffer including a first P-channel transistor, a first N-channel transistor, a second P-channel transistor and a second N-channel transistor,
the source of said first P-channel transistor connecting to said power-supply line for providing said first electric potential,
the source of said first N-channel transistor connecting to said power-supply line for providing said second electric potential,
the drain of said first P-channel transistor connecting to the source of said second P-channel transistor,
the drain of said second P-channel transistor connecting to the drain of said second N-channel transistor,
the gate of said first P-channel transistor connecting to the gate of said first N-channel transistor, and
the source of said second N-channel transistor connecting to the drain of said first N-channel transistor; and
said second N-channel transistor and said second P-channel transistor function as said control means.

5. The display apparatus according to claim 2 wherein:
said second scan means has a last-stage buffer including a P-channel transistor and an N-channel transistor,
the source of said P-channel transistor connecting to said power-supply line for providing said first electric potential,
the source of said N-channel transistor connecting to said power-supply line for said second electric potential,
the drain of said P-channel transistor connecting to the drain of said N-channel transistor, and
the gate of said P-channel transistor receiving scan pulses having a phase different from the phase of scan pulses received by the gate of said N-channel transistor; and
said P-channel transistor and said N-channel transistor function as said control means.

6. A driving method adopted by a display apparatus comprising:
a pixel array section including pixel circuits laid out to form a matrix as pixel circuits each having
an electro-optical device,
a write transistor configured to carry out a voltage storing process to sample an input signal voltage and store said sampled input signal voltage into said pixel circuit,
a holding capacitor configured to hold said sampled input signal voltage stored in said pixel circuit by said write transistor, and
a driving transistor configured to drive said electro-optical device on the basis of said input signal voltage held by said holding capacitor;
first scan means connected to rows of said pixel circuits in said pixel array section for carrying out a selective scan operation on said pixel circuits in said pixel array section in row units and driving each of said write transistors to carry out said voltage storing process; and
second scan means connected to said rows of said pixel circuits in said pixel array section for selectively supplying either a first electric potential or a second electric potential lower than said first electric potential synchronously with said selective scan operation carried out by said first scan means to power-supply feed lines for feeding a current to each of said driving transistors,
whereby said power-supply feed line is sustained in a floating state during a period ending at a time not earlier than the start of said voltage storing process carried out by said write transistor to store said input signal voltage in said holding capacitor after a voltage corresponding to the threshold voltage of said driving transistor has been held in said holding capacitor prior to said voltage storing process.

7. An electronic equipment including a display apparatus, said display apparatus comprising:
a pixel array section including pixel circuits laid out to form a matrix as pixel circuits each having
an electro-optical device,
a write transistor configured to carry out a voltage storing process to sample an input signal voltage and store said sampled input signal voltage into said pixel circuit,
a holding capacitor configured to hold said sampled input signal voltage stored in said pixel circuit by said write transistor, and
a driving transistor configured to drive said electro-optical device on the basis of said input signal voltage held by said holding capacitor;
first scan means connected to rows of said pixel circuits in said pixel array section for carrying out a selective scan operation on said pixel circuits in said pixel array section in row units and driving each of said write transistors to carry out said voltage storing process;
second scan means connected to said rows of said pixel circuits in said pixel array section for selectively supplying either a first electric potential or a second electric potential lower than said first electric potential synchronously with said selective scan operation carried out by said first scan means to power-supply feed lines for feeding a current to each of said driving transistors; and
control means for sustaining said power-supply feed line in a floating state during a period ending at a time not earlier than the start of said voltage storing process carried out by said write transistor to store said input signal voltage in said holding capacitor after a voltage corresponding to the threshold voltage of said driving transistor has been held in said holding capacitor prior to said voltage storing process.

8. A display apparatus comprising:
a pixel array section including pixel circuits laid out to form a matrix as pixel circuits each having
an electro-optical device,
a write transistor configured to carry out a voltage storing process to sample a video signal and store said sampled video signal into said pixel circuit,
a holding capacitor configured to hold said sampled video signal stored in said pixel circuit by said write transistor, and
a driving transistor configured to drive said electro-optical device on the basis of said video signal held by said holding capacitor;
a first scan section connected to rows of said pixel circuits in said pixel array section and configured carry out a selective scan operation on said pixel circuits in said pixel array section in row units and drive each of said write transistors to carry out said voltage storing process;
a second scan section connected to said rows of said pixel circuits in said pixel array section and configured to selectively supply either a first electric potential or a second electric potential lower than said first electric potential synchronously with said selective scan operation carried out by said first scan section to power-supply feed lines for feeding a current to each of said driving transistors; and
a control section configured to sustain said power-supply feed line in a floating state during a period ending at a time not earlier than the start of said voltage storing process carried out by said write transistor to store said video signal in said holding capacitor after a voltage corresponding to the threshold voltage of said driving transistor has been held in said holding capacitor prior to said voltage storing process.
